(19) United States
(12) Patent Application Publication
(10) Pub. No.: US 2025/0234267 A1
(43) Pub. Date: Jul. 17, 2025

(54) DUAL-STEERING OPERATIONS FOR WIRELESS COMMUNICATIONS

(71) Applicant: QUALCOMM Incorporated, San Diego, CA (US)

(72) Inventors: Juan ZHANG, San Diego, CA (US); Ajith Tom PAYYAPPILLY, San Diego, CA (US); Aziz GHOLMIEH, Del Mar, CA (US); Dario Serafino TONESI, San Diego, CA (US)

(21) Appl. No.: 18/919,060

(22) Filed: Oct. 17, 2024

Related U.S. Application Data
(60) Provisional application No. 63/620,717, filed on Jan. 12, 2024.

(51) Int. Cl. H04W 40/02; H04W 8/20

(52) U.S. Cl. CPC H04W 40/02; H04W 8/20

(57) ABSTRACT

Methods, systems, and devices for wireless communication are described. A user equipment (UE) may be configured to support multiple subscriber identity modules (SIMs) and multiple corresponding subscribers that may provide wireless services to the UE. Each of the SIMs may be associated with a corresponding protocol stack. The UE may be configured with a layer that is distinct from the protocol stack, such as a dual-steer layer. The dual-steer layer may manage the routing and steering of data traffic associated with one or more of the protocol stacks of the UE. The UE may process, via the dual-steer layer, the data traffic via one or more of the protocol stacks of the UE based on the first set of UE route selection policy (URSP) rules, traffic information associated with the data traffic, and capabilities of one or more of the protocol stacks.

### CROSS REFERENCE

The present Application for Patent claims priority to U.S. Provisional Patent Application No. 63/620,717 by ZHANG et al., entitled “DUAL-STEERING OPERATIONS FOR WIRELESS COMMUNICATIONS,” filed Jan. 12, 2024, which is assigned to the assignee hereof and is expressly incorporated by reference herein.

### FIELD OF TECHNOLOGY

The following relates to wireless communications, including dual-steering operations for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support dual-steering operations for wireless communications. For example, the described techniques enable a layer, such as a dual-steer layer, of a user equipment (UE) that supports multiple subscriptions. The UE may be configured with one or more protocol stacks to support the multiple subscriptions, and the one or more protocol stacks may each be configured to communicate with an associated access network. The dual-steer layer may be distinct from the protocol stacks and may be configured to manage, for example steer or route, data traffic for the protocol stacks and over the associated access networks. The dual-steer layer may manage the data traffic based on UE route selection policy (URSP) rules.

A method for wireless communications by a UE is described. The method may include transmitting, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions, receiving, based on the capability of the UE, a first set of URSP rules for steering the data traffic associated with the UE, and routing, via a higher layer of the UE based on the first set of URSP rules and on the capability of the UE, the data traffic associated with the UE via one or both of the first protocol stack or the second protocol stack.

A UE for wireless communications is described. The UE may include one or more memories storing processor executable code, and one or more processors coupled with the one or more memories. The one or more processors may individually or collectively operable to execute the code to cause the UE to transmit, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions, receive, based on the capability of the UE, a first set of URSP rules for steering the data traffic associated with the UE, and routing, via a higher layer of the UE based on the first set of URSP rules and on the capability of the UE, the data traffic associated with the UE via one or both of the first protocol stack or the second protocol stack.

Another UE for wireless communications is described. The UE may include means for transmitting, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions, means for receiving, based on the capability of the UE, a first set of URSP rules for steering the data traffic associated with the UE, and means for routing, via a higher layer of the UE based on the first set of URSP rules and on the capability of the UE, the data traffic associated with the UE via one or both of the first protocol stack or the second protocol stack.

A non-transitory computer-readable medium storing code for wireless communications is described. The code may include instructions executable by one or more processors to transmit, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions, receive, based on the capability of the UE, a first set of URSP rules for steering the data traffic associated with the UE, and routing, via a higher layer of the UE based on the first set of URSP rules and on the capability of the UE, the data traffic associated with the UE via one or both of the first protocol stack or the second protocol stack.

In some examples of the method, UEs, and non-transitory computer-readable medium described herein, the first set of URSP rules may be received via the first protocol stack and the method, apparatuses, and non-transitory computer-readable medium may include further operations, features, means, or instructions for receiving, via the second protocol stack and based on the capability of the UE, a second set of URSP rules for steering the data traffic, where the first set of URSP rules may be associated with the first protocol stack and the second set of URSP rules may be associated with the second protocol stack.

In some examples of the method, UEs, and non-transitory computer-readable medium described herein, the first set of URSP rules may be received via the higher layer of the UE and may be associated with both the first protocol stack and the second protocol stack.

In some examples of the method, UEs, and non-transitory computer-readable medium described herein, each rule of the first set of URSP rules may include a traffic descriptor and a set of route selection descriptors (RSDs), and each RSD of the set of RSDs may include: a preferred access type indicating whether to perform single steering or dual-steering and a validity field indicating one or more radio access technology (RAT) capabilities corresponding to one or more of the first protocol stack, the second protocol stack, the first subscription, or the second subscription, or any combination thereof.

In some examples of the method, UEs, and non-transitory computer-readable medium described herein, routing the data traffic via one or both of the first protocol stack or the second protocol stack may include operations, features, means, or instructions for routing the data traffic based on a first URSP rule, the first URSP rule based on traffic information associated with the data traffic and one or more traffic descriptors associated with one or more URSP rules of the first set of URSP rules.

In some examples of the method, UEs, and non-transitory computer-readable medium described herein, routing the data traffic based on the first URSP rule may include operations, features, means, or instructions for routing the data traffic via both the first protocol stack and the second protocol stack based on the preferred access type associated with a first RSD associated with the first URSP rule for use in routing the data traffic, the first RSD based on a capability of one or both of the first protocol stack and the second protocol stack and one or more validity indicators associated with one or more RSDs associated with the first URSP rule.

In some examples of the method, UEs, and non-transitory computer-readable medium described herein, routing the data traffic based on the first URSP rule may include operations, features, means, or instructions for routing the data traffic via one of the first protocol stack or the second protocol stack based on the preferred access type associated with a first RSD associated with the first URSP rule for use in routing the data traffic, the first RSD based on a capability associated with one or both of the first protocol stack and the second protocol stack and one or more validity indicators associated with one or more RSDs associated with the first URSP rule.

In some examples of the method, UEs, and non-transitory computer-readable medium described herein, routing the data traffic based on the first URSP rule may include operations, features, means, or instructions for routing the data traffic via one of the first protocol stack or the second protocol stack based on a first RSD associated with the first URSP rule for use in routing the data traffic, the first RSD based on one RSD being associated with the first URSP rule and the validity indicator associated with the first RSD being empty.

In some examples of the method, UEs, and non-transitory computer-readable medium described herein, each RSD of the set of RSDs includes a subscription validity indicator identifying a protocol stack for routing the data traffic.

In some examples of the method, UEs, and non-transitory computer-readable medium described herein, routing the data traffic based on the first URSP rule may include operations, features, means, or instructions for routing the data traffic via the protocol stack identified by the subscription validity indicator associated with a first RSD based on the preferred access type associated with the first RSD indicating single steering, the first RSD associated with the first URSP rule for use in routing the data traffic and based on a capability of one or both of the first protocol stack and the second protocol stack and one or more validity indicators associated with one or more RSDs associated with the first URSP rule.

In some examples of the method, UEs, and non-transitory computer-readable medium described herein, routing the data traffic based on the first URSP rule may include operations, features, means, or instructions for routing the data traffic via one or both of the first protocol stack or the second protocol stack based on the subscription validity indicator associated with a first RSD associated with the first URSP rule for use in routing the data traffic being empty, the first RSD based on a capability of one or both of the first protocol stack and the second protocol stack and one or more validity indicators associated with one or more RSDs associated with the first URSP rule.

In some examples of the method, UEs, and non-transitory computer-readable medium described herein, routing the data traffic via one or both of the first protocol stack or the second protocol stack may include operations, features, means, or instructions for routing the data traffic via both of the first protocol stack or the second protocol stack.

Some examples of the method, UEs, and non-transitory computer-readable medium described herein may further include operations, features, means, or instructions for initiating, at the first protocol stack, a first packet data unit (PDU) session, initiating, at the second protocol stack, a second PDU session, transmitting, to a core network and via the first protocol stack, a first request to establish the first PDU session, where the first request indicates an identifier associated with the second protocol stack and an identifier associated with the second PDU session, and transmitting, to the core network and via the second protocol stack, a second request to establish the second PDU session, where the second request indicates an identifier associated with the first protocol stack and an identifier associated with the first PDU session.

A method for wireless communications by a network entity is described. The method may include receiving, from a UE, an indication of a capability of the UE to steer data traffic associated with the UE via a set of multiple protocol stacks of the UE, where each protocol stack of the UE corresponds to a respective subscription of a set of multiple subscriptions of the UE, updating, based on the capability of the UE, a first set of URSP rules to support a dual-steering functionality at the UE, and transmitting, to the UE, the first set of URSP rules.

A network entity for wireless communications is described. The network entity may include one or more memories storing processor executable code, and one or more processors coupled with the one or more memories. The one or more processors may individually or collectively operable to execute the code to cause the network entity to receive, from a UE, an indication of a capability of the UE to steer data traffic associated with the UE via a set of multiple protocol stacks of the UE, where each protocol stack of the UE corresponds to a respective subscription of a set of multiple subscriptions of the UE, updating, based at least in part on the capability of the UE, a first set of URSP rules to support a dual-steering functionality at the UE, and transmit, to the UE, the first set of URSP rules.

Another network entity for wireless communications is described. The network entity may include means for receiving, from a UE, an indication of a capability of the UE to steer data traffic associated with the UE via a set of multiple protocol stacks of the UE, where each protocol stack of the UE corresponds to a respective subscription of a set of multiple subscriptions of the UE, means for updating, based on the capability of the UE, a first set of URSP rules to support a dual-steering functionality at the UE, and means for transmitting, to the UE, the first set of URSP rules.

A non-transitory computer-readable medium storing code for wireless communications is described. The code may include instructions executable by one or more processors to receive, from a UE, an indication of a capability of the UE to steer data traffic associated with the UE via a set of multiple protocol stacks of the UE, where each protocol stack of the UE corresponds to a respective subscription of a set of multiple subscriptions of the UE, updating, based at least in part on the capability of the UE, a first set of URSP rules to support a dual-steering functionality at the UE, and transmit, to the UE, the first set of URSP rules.

In some examples of the method, network entities, and non-transitory computer-readable medium described herein, the first set of URSP rules may be associated with a first protocol stack of the set of multiple protocol stacks of the UE and the method, apparatuses, and non-transitory computer-readable medium may include further operations, features, means, or instructions for transmitting, based on the capability of the UE, a second set of URSP rules to support the dual-steering functionality at the UE, where the second set of URSP rules may be associated with a second protocol stack of the set of multiple protocol stacks of the UE.

In some examples of the method, network entities, and non-transitory computer-readable medium described herein, the first set of URSP rules may be associated with the set of multiple protocol stacks of the UE.

In some examples of the method, network entities, and non-transitory computer-readable medium described herein, each rule of the first set of URSP rules may include a traffic descriptor and a set of RSDs, and each RSD of the set of RSDs may include: a preferred access type indicating whether to perform single steering or dual-steering and a validity field indicating one or more RAT capabilities corresponding to one or more of a first protocol stack of the set of multiple protocol stacks, a second protocol stack of the set of multiple protocol stacks, a first subscription of the set of multiple subscriptions, or a second subscription of the set of multiple subscriptions, or any combination thereof.

In some examples of the method, network entities, and non-transitory computer-readable medium described herein, each RSD of the set of RSDs includes a subscription validity indicator identifying which protocol stack of the set of multiple protocol stacks of the UE to route traffic through.

Some examples of the method, network entities, and non-transitory computer-readable medium described herein may further include operations, features, means, or instructions for receiving, from the UE, a first request to establish a first PDU session associated with a first protocol stack of the set of multiple protocol stacks of the UE, where the first request includes an indication of an identifier associated with a second protocol stack of the set of multiple protocol stacks of the UE and an identifier associated with a second PDU session associated with the second protocol stack.

Some examples of the method, network entities, and non-transitory computer-readable medium described herein may further include operations, features, means, or instructions for receiving, from the UE, a second request to establish the second PDU session, where the second request includes an indication of an identifier associated with the first protocol stack and an identifier associated with the first PDU session.

Some examples of the method, network entities, and non-transitory computer-readable medium described herein may further include operations, features, means, or instructions for associating, based on receiving the first request and the second request, the first PDU session and the second PDU session with the UE.

### BRIEF DESCRIPTION OF THE DRAWINGS

FIGS. 1 and 2 show examples of wireless communications systems that support dual-steering operations for wireless communications in accordance with one or more aspects of the present disclosure.

FIG. 3 through 5 show an example of a user equipment and access networks that support dual-steering operations for wireless communications in accordance with one or more aspects of the present disclosure.

FIG. 6 shows an example of a process flow that supports dual-steering operations for wireless communications in accordance with one or more aspects of the present disclosure.

FIGS. 7 and 8 show block diagrams of devices that support dual-steering operations for wireless communications in accordance with one or more aspects of the present disclosure.

FIG. 9 shows a block diagram of a communications manager that supports dual-steering operations for wireless communications in accordance with one or more aspects of the present disclosure.

FIG. 10 shows a diagram of a system including a device that supports dual-steering operations for wireless communications in accordance with one or more aspects of the present disclosure.

FIGS. 11 and 12 show block diagrams of devices that support dual-steering operations for wireless communications in accordance with one or more aspects of the present disclosure.

FIG. 13 shows a block diagram of a communications manager that supports dual-steering operations for wireless communications in accordance with one or more aspects of the present disclosure.

FIG. 14 shows a diagram of a system including a device that supports dual-steering operations for wireless communications in accordance with one or more aspects of the present disclosure.

FIGS. 15 through 19 show flowcharts illustrating methods that support dual-steering operations for wireless communications in accordance with one or more aspects of the present disclosure.

### DETAILED DESCRIPTION

Various aspects of the present disclosure relate to a wireless communication device, such as a user equipment (UE), that may be configured with multiple subscriptions to support one or multiple wireless services over one or more access networks. In particular, the present disclosure relates to a new layer of a UE that may be configured to manage data traffic associated with the multiple subscriptions. For instance, the UE may be configured to support the multiple subscriptions via corresponding subscriber identity modules (SIMs) associated with the UE (e.g., included in the UE or electronically registered for the UE such as in an electronic SIM (eSIM)). By way of example, a multi-SIM UE having two SIMs may include a first SIM that provides a subscription for international voice calling services using a first network and a second SIM that provides a subscription for domestic voice calling services using a second network. As another example, the multi-SIM UE may include one SIM that is used for a personal subscription using a first network and another that is used for a business subscription using the same network.

Each of the SIMs may be configured to connect the UE to a core network through a network entity, such as a base station or an access network. The multiple SIMs may be configured to connect to one or more core networks through the same or different network entities. The core networks may provide the wireless services supported by the subscriptions. The UE may be configured with multiple protocol stacks to support the multiple SIMs and corresponding subscriptions. For instance, each SIM may be associated with a corresponding protocol stack. The protocol stacks may be configured in a modem of the UE and may be used to route data traffic (e.g., data from one or more applications of the UE) from an operating system of the UE and through a connection, such as a protocol data unit (PDU) session, to one or more core networks.

In accordance with aspects of the present disclosure, the UE may be configured, at the modem, with a layer or other functionality that is distinct from one or more protocol stacks associated with one or more subscriptions. The layer may be a higher layer, such as a dual-steer layer, that manages the routing and steering of data traffic for the multiple protocol stacks of the UE, over the one or more access networks, and to one or more core networks. In some cases, the dual-steer layer may be configured to route or steer the data traffic over a single protocol stack of the UE. In other cases, the UE may be configured to enable the dual-steer layer to route or steer the data traffic over multiple ones of the protocol stacks at a given time. The steering of the data via the multiple protocol stacks may be referred to as dual-steering.

The dual-steer layer may be configured with functionality to route or steer data traffic for the multiple protocol stacks, over the one or multiple access networks, based on one or more UE route selection policy (URSP) rules. The UE may receive the URSP rules from one or more of the core networks (either directly or indirectly via a radio access network (RAN) node, for instance). The URSP rules may provide rules or conditions under which the dual-steer layer is to route or steer the data traffic to one or more of the protocol stacks. In some cases, the routing rules may be based on capabilities associated with the UE, manufacturer configuration of the UE, subscription choices (such as whether the user is subscribed for a particular service, e.g., non-terrestrial network (NTN) or sixth generation (6G)), user preferences, traffic information associated with the data traffic, and the like.

The UE may be configured to associate a unique session, such as a PDU session, with each of the protocol stacks of the UE. For example, the UE may determine to establish, for each protocol stack, a unique PDU session associated with that protocol stack via a PDU session establishment procedure coordinated with one or more of the core networks. Once established, the UE and core network may communicate with one another, such as by transmitting and receiving data, via a PDU connection. The core network may use the PDU connection to transmit one or more URSP rules to the UE.

In some cases, the UE may inform the core network of its ability to support dual-steering and the core network may, in response, update one or more of the URSP rules to enable to UE to utilize its dual-steering capabilities. The core network may transmit the updated URSP rules to the UE and the UE may utilize the updated URSP rules to manage routing and steering the traffic over the appropriate protocol stacks.

By enabling the UE with a higher layer, such as a dual-steer layer, that is distinct from the protocol stacks or other functionality that manages data traffic for the protocol stacks, the UE may experience improved communication reliability, reduced latency, improved user experience related to reduced processing, and more efficient utilization of communication resources.

Aspects of the disclosure are initially described in the context of wireless communications systems. Aspects of the disclosure are further illustrated by and described with reference to apparatus diagrams, system diagrams, and flowcharts that relate to dual-steering operations for wireless communications.

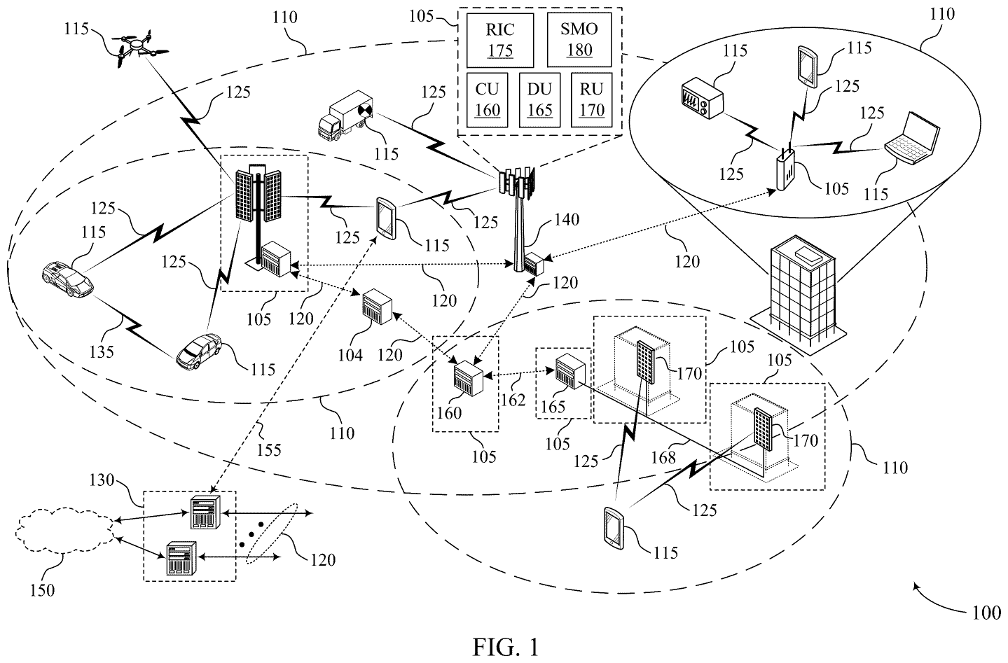

FIG. 1 shows an example of a wireless communications system 100 that supports dual-steering operations for wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In accordance with aspects described herein, a UE 115 may be configured with multiple protocol stacks. The multiple protocol stacks may correspond to multiple subscriptions that support one or multiple wireless services over one or network entities, such as one or more base stations 140. The protocol stack may refer to one or more protocol layers, which may be ordered in a hierarchical architecture (e.g., structure). In some examples, the UE 115 may be configured with a new layer, such as a dual-steer layer, that is distinct from the protocol stacks. The dual-steer layer may manage the routing and steering of data traffic for the protocol stacks, over the one or multiple access networks, and to one or more core networks as described herein based on one or more rules, information associated with the data traffic, and capabilities of the UE 115 or one or more of the protocol stacks of the UE 115.

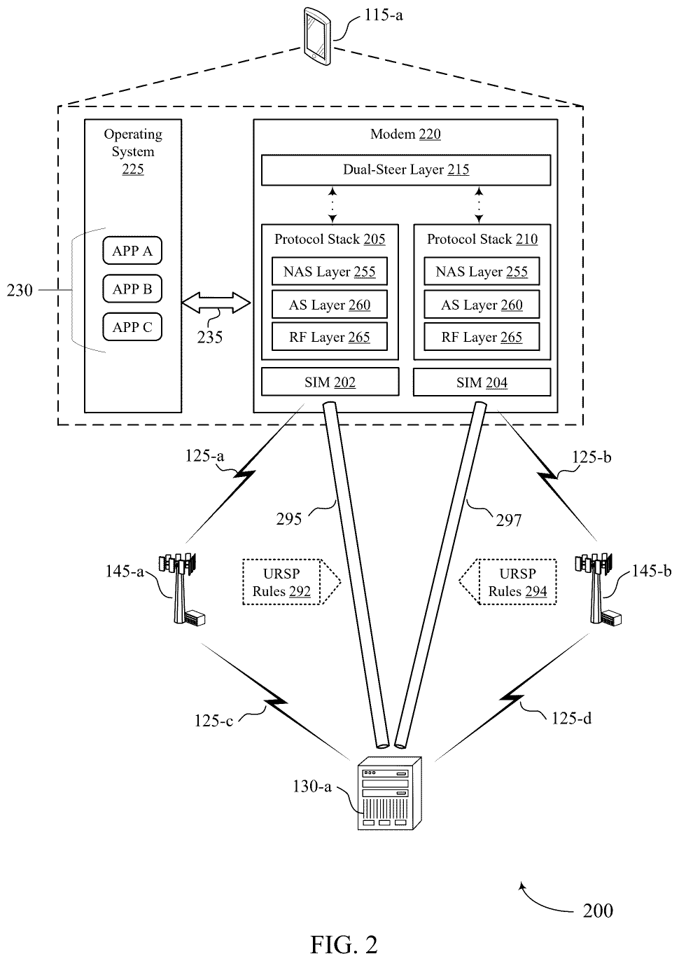

FIG. 2 shows an example of a wireless communications system 200 that supports dual-steering operations for wireless communications in accordance with one or more aspects of the present disclosure. In some examples, the wireless communications system 200 may implement or be implemented by aspects of the wireless communications system 100, as described with reference to FIG. 1. For example, the wireless communications system 200 may include a UE 115-a, an access network 145-a, an access network 145-b, and a core network 130-a, which may be examples of UEs 115, and core network 130, respectively, as described with reference to FIG. 1. The wireless communications system 200 may support multiple RATs including 4G LTE, 5G NR, or a combination thereof. For example, one or more of the access network 145-a or the access network 145-b may support one or more of 4G LTE or 5G NR. It should be noted that the wireless communications system 200 may support radio access technologies beyond 5G NR.

The UE 115-a and the access network 145-a may perform wireless communication (e.g., one or more of receiving, obtaining, transmitting, or outputting one or more of control information or data) via a communication link 125-a. Additionally, or alternatively, the UE 115-a and the access network 145-b may perform wireless communication (e.g., one or more of receiving, obtaining, transmitting, or outputting one or more of control information or data) via a communication link 125-b. The communication links 125-a and 125-b may be examples of communication links 125, as described with reference to FIG. 1.

The UE 115-a may support managing the routing or steering of data traffic for different wireless services over different access networks, such as one or more of the access networks 145-a or 145-b, each of which may communicate (e.g., one or more of receive, obtain, transmit, or output) one or more of control information or data to one or more core networks, such as the core network 130-a, to support the wireless services (e.g., applications enabled for the UE 115-a).

The one or more access networks 145-a and 145-b may provide connectivity to the UE 115-a with the core network 130-a to provide access to the wireless service (e.g., one or more applications enabled for the UE 115-a). For instance, the access network 145-a may communicate (e.g., one or more of receive, obtain, transmit, or output) one or more of control information or data with the core network 130-a via a communication link 125-c, or the access network 145-b may communicate (e.g., one or more of receive, obtain, transmit, or output) one or more of control information or data with the core network 130-a via a communication link 125-d. The communication links 125-c and 125-d may be examples of communication links 125, as described with reference to FIG. 1.

The UE 115-a may connect to the core network 130-a via the one or more of the access networks 145-a or 145-b, and based at least in part on a connection procedure. For example, the UE 115-a (or one or more of its protocol stacks) may perform a registration procedure, in which the UE 115-a (or one or more of its protocol stacks) may obtain an IP address, and the core network 130-a may establish a context (e.g., also referred to as UE context) for the UE 115-a, allowing the UE 115-a to communicate with other network entities (e.g., network functions). In response to the UE 115-a successfully completing the registration procedure, the UE 115-a (or one or more of its protocol stacks) may be connected to the core network 130-a. The core network 130-a may manage various functions, such as providing wireless services for subscriptions associated with the UE.

The UE 115-a may include, among other components, an operating system 225 and a modem 220. The operating system 225 may manage and support certain basic and common functions of the UE, such as scheduling tasks, managing hardware and software resources, controlling peripheral devices, executing applications, such as applications 230, and the like. The modem 220 may manage transmission of data to and from the UE 115-a. For instance, the modem 220 may manage the transmission of data associated with the applications 230 from the UE 115-a and to the core network 130-a. The UE 115-a may include one or more data interfaces 235 between the operating system 225 and the modem 220 to facilitate the transmission of data to and from the operating system 225 and the modem 220. For instance, the modem 220 may receive, from the operating system 225 and via the data interface 235, data traffic associated with one or more of the applications 230. Once received, the modem 220 may manage transmission of the data traffic to the core network 130-a. The modem 220 may also manage the reception of data traffic to the UE 115-a from the core network 130-a. Once received, the modem 220 may control transmission of the data traffic to the appropriate applications 230 via the data interface 235.

In some cases, the UE 115-a may be a multi-subscriber identity module (SIM) device and may be equipped with multiple SIMs. The multiple SIMs may allow the UE 115-a to register with and connect to one or more access networks and one or more core networks to access subscribed services associated with each SIM. For example, the UE 115-a may be equipped, such as at the modem 220, with a first SIM 202 and a second SIM 204. The first SIM 202 may be configured to connect with the access network 145-a to access services provided by one or more core networks, such as the core network 130-a. The second SIM 204 may be configured connect with the access network 145-b to access services provided by one or more core networks, such as the core network 130-a. In some cases, the access networks 145-a and 145-b may be the same access network. In other cases, the access networks 145-a and 145-b may be different networks. Further, although a single core network 130-a is shown in FIG. 2, in some cases, the services may be provided by more than one core network. The UE 115-a may register and connect to one or more of the access network 145-a or the access network 145-b using the first SIM 202 or the second SIM 204, respectively. The UE 115-a may further register and connect to the core network 130-a via one or more of the access network 145-a or the access network 145-b and using one or more of the first SIM 202 or the second SIM 204. Each of the first SIM 202 and the second SIM 204 of the UE 115-a may be associated with a subscriber identity, which may include an international mobile subscriber identity (IMSI) and the mobile subscriber integrated services digital network number (MSISDN).

To support the multiple SIM s, the modem 220 of the UE 115-a may be configured with multiple protocol stacks. Each of the multiple protocol stacks may be associated with one of the multiple SIM s and corresponding subscriptions. For instance, the modem 220 may be configured with a first protocol stack 205 and a second protocol stack 210. It should be noted that the UE 115-a may be equipped with more than two protocol stacks. The protocol stack 205 may be associated with the first SIM 202 (which may be associated with a first subscription) and the protocol stack 210 may be associated with the second SIM 204 (which may be associated with a second subscription). Each of the first protocol stack 205 and the second protocol stack 210 may include one or more protocol layers, which may be ordered in a hierarchical architecture.

For example, at a high level, each of the protocol stacks 205 and 210 may include one or more of a non-access stratum (NAS) layer 255, which may support traffic and signaling messages between the UE 115-a and the core network 130-a, as well as the establishment of communication sessions between the UE 115-a and the core network 130-a, an access stratum (AS) layer 260, which may support transporting data over the wireless connection, and an RF layer 265, which may support radio transmission and reception. The protocol stacks 205 and 210 may not be limited to the layers shown, but may include different or additional layers.

The modem 220 may be further configured with a new layer that may be distinct from the protocol stacks 205 and 210. For instance, the modem 220 may be configured with a higher layer, such as a dual-steer layer 215. The dual-steer layer 215 may be distinct from both the protocol stack 205 and the protocol stack 210. For instance, the dual-steer layer 215 may be separate (e.g., unencapsulated) from both the protocol stack 205 and the protocol stack 210, including the different protocol layers within each of the protocol stack 205 and the protocol stack 210. The dual-steer layer 215 may reside (e.g., located) above the protocol stack 205 and the protocol stack 210. While the dual-steer layer 215 may reside above the protocol stack 205 and the protocol stack 210, the dual-steer layer 215 may interface with other layers or components (e.g., hardware, software) above and below the dual-steer layer 215. As such, the dual-steer layer 215 may support interoperability with one or more of the different protocol layers within each of the protocol stack 205 and the protocol stack 210.

The dual-steer layer 215 may also include a control plane and a user plane. The control plane of the dual-steer layer 215 may manage steering or routing data traffic to one or more protocol stacks 205 and 210 of the UE 115-a, based at least in part on steering rules, such as URSP rules, that may be obtained (e.g., received) from a network (e.g., the core network 130-a). The dual-steer layer 215 may also be configured with a mechanism (e.g., a trigger condition) for the UE 115-a to receive the URSP rules, for example, in response to registration of the UE 115-a or one or more of the protocol stacks 205 and 210 of the UE 115-a with the core network 130-a, where the registration includes an indication of the capability to support dual-steering, in response to a PDU session establishment by one of the protocol stacks, such as the protocol stack 205. In some cases, the URSP rules may be updated rules, such as when the indication of the capability to support dual-steering is provided to the core network 130-a. The updated URSP rules may be configured to support the dual-steering capabilities of the UE 115-a or the one or more of the protocol stacks 205 and 210 of the UE 115.

In some cases, the user plane of the dual-steer layer 215 may support one or more of a hypertext transfer protocol (HTTP) (e.g., HTTP3), a multipath QUIC (MP-QUIC) protocol, user datagram protocol (UDP), or an IP. The dual-steer layer 215 may determine to establish at least a quantity of MP-QUIC connections based at least in part on a quantity of quality of service (QoS) flows associated with both the protocol stack 205 and the protocol stack 210. For instance, the UE 115-a may establish one MP-QUIC connection per QoS flow. Additionally, or alternatively, the user plane of the dual-steer layer 215 may support one or more of a multipath transmission control protocol (MPTCP), a TCP, an IP, or a Aware Traffic Steering, Switching, and Splitting-Lower Layer (ATSSS-LL) protocol.

The dual-steer layer 215 may further manage constraints on the UE 115-a depending on the hardware/software capabilities or device architecture configuration of the UE 115-a, e.g., RF bands combination capabilities, chipset capabilities, manufacturer configurations, user preferences, subscription choices, or a combination thereof. In this way, the decision of routing and steering may be UE-centric rather than network-based.

The dual-steer layer 215 may coordinate session management functionality for each of the first protocol stack 205 or the second protocol stack 210, triggering establishment of one or more corresponding PDU sessions and connections by one or more of the protocol stack 205 or the protocol stack 210. For instance, the dual-steer layer 215 may coordinate the establishment of a PDU session 295 between the first protocol stack 205 and the core network 130-a, and the establishment of a PDU session 297 between the second protocol stack 210 and the core network 130-a. The dual-steer layer 215 may cause the first protocol stack 205 to initiate the PDU session 295 at the UE 115-a and may cause transmission of a message (e.g., PDU session establishment request message), via the access network 145-a, to the core network 130-a requesting the establishment of the PDU session 295 between the core network 130-a and the first protocol stack 205 of the UE 115-a. The UE 115-a may receive, from the core network 130-a and via the access network 145-a, a PDU session establishment response message indicating whether the request was accepted or rejected. Upon acceptance of the request to establish the PDU session 295, a PDU session 295 connection may be established between the core network 130-a and the first protocol stack 205. For instance, the core network 130-a may associate (e.g., bind) the requested PDU session to the corresponding protocol stack. For instance, the core network 130-a may bind the PDU session 295 to the protocol stack 205. Similarly, the dual-steer layer 215 may cause the second protocol stack 210 to initiate the PDU session 297 at the UE 115-a and may cause transmission of a PDU session establishment request message, via the access network 145-b, to the core network 130-a requesting the establishment of the PDU session 297 between the core network 130-a and the second protocol stack 210 of the UE 115-a. The UE 115-a may receive, from the core network 130-a and via the access network 145-b, a PDU session establishment response message indicating whether the request was accepted or rejected. Upon acceptance of the request to establish the PDU session 297, a PDU session 297 connection may be established between the core network 130-a and the second protocol stack 210. For instance, the core network 130-a may bind the PDU session 297 to the protocol stack 210.

Once the PDU session is established the core network 130-a may transmit, to the UE 115-a, via the PDU session connection, one or more URSP rules. The core network 130-a may include a unified data repository (UDR), which may store UE information (e.g., subscription information) that may be used by other network entities, such as a policy control function (PCF) of the core network 130-a to manage (e.g., update, remove, modify, adjust, delete, store) URSP rules for the UE 115-a. The core network 130-a may also include a unified data management function (UDM), which may store the UE information. The core network 130-a may also include an access and mobility management function (AMF), which may obtain the UE information from the UDM and output (e.g., forward, transmit, route) the UE information to the PCF of the core network 130-a. Based on the UE information, the PCF of the core network 130-a may provide the URSP rules to one or more of the UE 115-a, the access network 145-a, or the access network 145-b.

In some cases, the URSP rules may be provided (e.g., transmitted) by the core network 130-a to the UE 115-a via one or more of the PDU sessions. For instance, URSP rules 292 may be transmitted from the core network 130-a to the protocol stack 205 of the UE 115-a via the PDU session 295 connection, or URSP rules 294 may be transmitted from the core network 130-a to the protocol stack 210 of the UE 115-a via the PDU session 297. Alternatively, both URSP rules 292 and URSP rules 294 may be transmitted to the UE 115-a via the PDU session 295 and PDU session 297 connections, respectively. In some cases, the access networks 145-a or 145-b may obtain one or more of the URSP rules 292 and 294 from the core network 130-a, and the access networks 145-a or 145-b may transmit signaling carrying one or more of the URSP rules 292 and URSP rules 294 to the UE 115-a, via one or both of the protocol stacks 205 and 210. The UE 115-a may process (e.g., demodulate, decode) the signaling to identify the one or more URSP rules 292 and 294 associated with one or both of the protocol stacks 205 and 210. The dual-steer layer 215 may obtain (e.g., receive) one or more of the URSP rules 292 and 294 from one or both of the protocol stacks 205 and 210,

In some cases, the URSP rules 292 and URSP rules 294 may be the same set of rules. In other cases, the URSP rules 292 and URSP rules 294 may be different rules that independently apply to a particular one of the protocol stacks. For instance, the URSP rules 292 may include rules to be applied by the first protocol stack 205, while the URSP rules 294 may include rules to be applied by the second protocol stack 210.

The URSP rules 292 and 294 may each include a set of rules to be used by one or more of the protocol stacks 205 and 210 to determine how to route traffic from the UE 115-a to the core network. For instance, URSP rules may provide one or more rules or conditions under which the dual-steer layer 215 is to coordinate the routing or steering of data traffic to one or more of the protocol stacks 205 and 210. In some cases, the URSP rules may be based on or dependent on the capabilities associated with the UE 115-a or the subscriptions associated with the different protocol stacks 205 and 210 (e.g., RAT capabilities associated with subscriptions), manufacturer configuration of the UE, subscription choices (such as whether the user is subscribed for a particular service, e.g., NTN or 6G), user preferences, traffic information associated with the data traffic, and the like.

Each URSP rule may include information mapping different types of data traffic to one or more rules that indicate where to route that type of data traffic when certain conditions are met. For instance, each URSP rule may include a traffic descriptor. The different types of data traffic may be indicated in the URSP rule by traffic information (also referred to as a “traffic descriptor”), which may determine when the particular URSP rule is applicable. The dual-steer layer 215 may determine that a URSP rule is applicable when the traffic descriptor matches corresponding information of an application, such as one of applications 230, associated with data traffic to be routed. The traffic descriptor may, in turn, be mapped in the URSP rule to one or more route selection descriptors (RSDs). The RSDs may include one or more parameters or fields that indicate the different conditions under which the corresponding type of data traffic (as indicated by the traffic descriptor) should be routed to a particular PDU session (such as via an associated protocol stack) also indicated by the RSD. For instance, the RSD fields may indication information, such as an application descriptor, a data network name (DNN), a PDU session information a preferred access type, etc.

The dual-steer layer 215 may determine, based at least in part on one or more of the traffic descriptor and the RSDs, whether a particular URSP rule applies to particular application data traffic and how (such as via which protocol stack and corresponding PDU session) to route such data traffic.

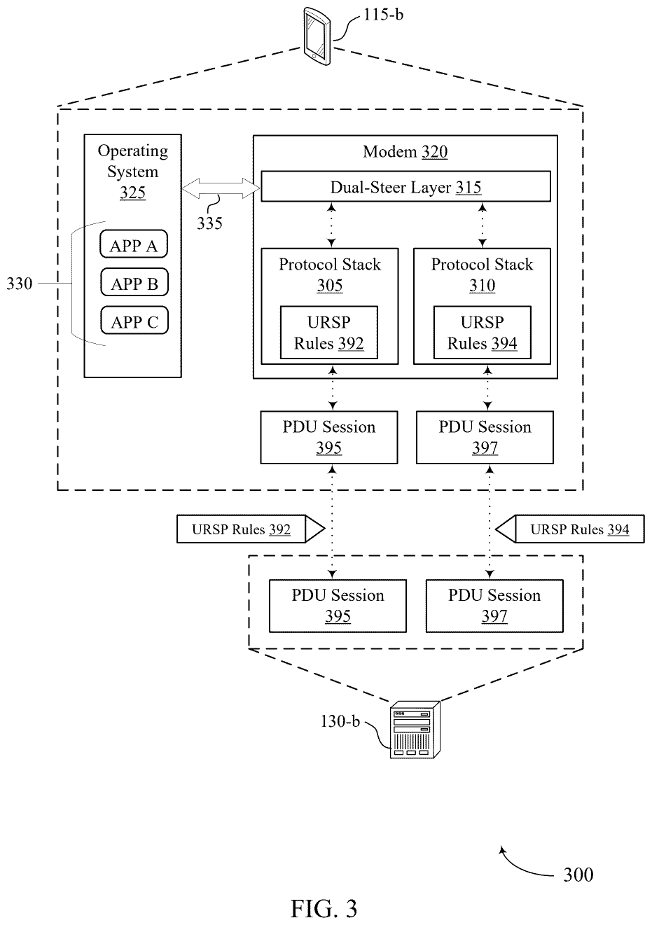

FIG. 3 shows an example of a block diagram 300 of a UE 115-b and a core network 130-b that support dual-steering operations for wireless communications in accordance with one or more aspects of the present disclosure. In some examples, the UE 115-b and the core network 130-b may implement or be implemented by aspects of the wireless communications system 100 or the wireless communications system 200, as described with reference to FIGS. 1 and 2, respectively. For example, the UE 115-b may be an example of UE 115 or UE 115-a, as described with reference to FIGS. 1 and 2, respectively. The core network 130-b may be an example of core network 130 or core network 130-a, as described with reference to FIGS. 1 and 2, respectively.

The UE 115-b may include an operating system 325 and a modem 320. The operating system 325 may support one or more applications 330. The operating system 325 may be an example of the operating system 225, as described with reference to FIG. 2. The modem 320 may interface with the operating system 325, via the data interface 335, to receive and transmit data traffic associated with the one or more applications 330. The modem 320 may be an example of modem 220, as described with reference FIG. 2.

The modem 320 may be configured with multiple subscriptions (such as via multiple SIMs) and corresponding protocol stacks to support one or multiple wireless services over one or more access networks, such as described with reference to FIGS. 1 and 2. For example, the UE 115-b may be configured with a protocol stack 305 and a protocol stack 310, which may be examples of protocol stacks 205 and 210, as described with reference to FIG. 2.

The modem 320 may additionally be configured to support dual-steering and may be configured with a dual-steer layer 315, which may be an example of dual-steer layer 215 as described with reference to FIG. 2. The dual-steer layer 315 may be configured to route or steer data traffic received from the operating system 325, via the data interface 335, to one or more of the protocol stacks 305 and 310. The data may be routed from one or more of the protocol stacks 305 and 310 and to the core network 130-b via one or more corresponding PDU sessions 395 and 397.

In some cases, the UE 115-b may transmit an indication of its dual-steering capabilities to the core network 130-b. For instance, one or more of the protocol stacks 305 and 310 of the UE 115-b may transmit, via one or more of the PDU sessions 395 and 397 (or in some cases via a corresponding access network), signaling comprising an indication of the dual-steering capabilities of the protocol stack. In some cases, the signaling may comprise additional information, such as information identifying a quantity of subscriptions or protocol stacks for which the UE 115-b is configured, or information related to other capabilities of the UE 115-b. In some cases. the information indicating the dual-steering information and the additional information may be provided to the core network 130-b as part of a process where one or more of the protocol stacks 305 and 310 of the UE 115-b register with the core network 130-b. That is, the protocol stacks 305 and 310 of the UE 115-e may register with the core network 130-b to obtain access to wireless services associated with the core network 130-b. To register with the network, the protocol stacks 305 and 310 of may perform a registration procedure, which may include exchange of signaling (e.g., information) with one or more of the corresponding access networks or the core network 130-b.

In response to receiving the information indicating the dual-steering capabilities of the UE 115-b or one or more of the protocol stacks 305 and 310, the core network 130-b may transmit to the UE 115-b, via one or more of the PDU sessions 395 and 397, one or more URSP rules. For instance, in the example of FIG. 3, the core network 130-b may send URSP rules via both the PDU sessions 395 and 397. For example, URSP rules 392 may be sent, via the PDU session 395, to the protocol stack 305 of the UE 115-b, and URSP rules 394 may be sent, via the PDU session 395, to the protocol stack 310 of the UE 115-b. The URSP rules 392 and 394 may be the same set of rules or different sets of rules. In this case, URSP rules 392 may be associated with the protocol stack 305, and the dual-steer layer 315 may use the URSP rules 392 to make routing decisions associated with the protocol stack 305. Similarly, in this example, URSP rules 394 may be associated with the protocol stack 310, and the dual-steer layer 315 may use the URSP rules 394 to make routing decisions associated with the protocol stack 310.

The URSP rules 392 and 394 may each be a set of URSP rules and may include one or more URSP rules. Each of the URSP rules may include a traffic descriptor identifying a type of data traffic (such as information identifying traffic from a particular one of the applications 330) and a mapping to one or more RSDs that indicate where or how to route the corresponding type of data traffic (as indicated by the traffic identifier) when certain conditions are met. For instance, each RSD may include one or more parameters or fields that provide the indications of where or how to route the corresponding type of data traffic and the conditions that are to be met in order to trigger such routing. In some cases, the RSD may be configured with a new field, such as a capability validity field that may indicate a device capability to be met in order for the RSD to be valid for use by the dual-steer layer 315 in routing data traffic. For instance, the capability validity field (also referred to as a “RAT validity field” may be associated with one or a combination of RATs supported by a device for accessing one or more of the access networks or the core network 130-a. For instance, the capability validity field may provide an indication of one or a combination of RAT capabilities, associated one or more of the protocol stacks of the UE 115-b, to be met in order for the associated RSD to be valid for use by the dual-steer layer 315 in routing data traffic.

For example, URSP rules 392 may be received at the protocol stack 305. The URSP rules 392 may include a first URSP rule having a first RSD that may include a capability validity field that indicates a combination of NR and LTE. In this case, the first RSD may be determined, by the dual-steer layer 315, to be valid for managing routing of data traffic at the protocol stack 305 when one protocol stack, such as protocol stack 305, supports NR, and another protocol stack, such as protocol stack 310, supports LTE. As another example, a second RSD of the first URSP (received at the protocol stack 305) may include a capability validity field that indicates a combination of LTE and LTE. In this example, the second RSD may be determined, by the dual-steer layer 315, to be valid for managing routing of data traffic at the protocol stack 305 when one protocol stack, such as protocol stack 305, supports LTE, and another protocol stack, such as protocol stack 310, also supports LTE. In the case where the RATs of the protocol stacks 305 and 310 do not match any of the combinations of RATs indicated by the capability validity field of the first RSD or the second RSD of the URSP rules 392, the dual-steer layer 315 may determine that neither of the first or second RSDs are valid for managing routing at the protocol stack 305. As a result, corresponding data traffic might not be routed using the protocol stack 305 and, thus, might not be transmitted to the core network 130-b (such as when no other RSDs of the first URSP or no other URSP rules of the URSP rules 392 are valid).

The capability validity field might not be limited to a combination of two RATs and may, instead, include any number of RATs, such as, for example, a number of RATs that corresponds to a number of protocol stacks configured for the UE 115-b. In some cases, the capability validity field may include fewer RAT indications than a number of protocol stacks configured for the UE 115-b. For instance, in some cases, the capability validity field of an RSD of a URSP rule may indicate a single RAT indication or no RAT indication (e.g., the capability validity field may be empty).

In the case where the capability validity field of an RSD indicates a single RAT, the dual-steer layer 315 may use the associated RSD to route the data traffic if the RAT associated with the protocol stack for which that URSP is applicable corresponds to the indicated RAT. For instance, if URSP rules 392, received at and associated with the protocol stack 305, includes a first URSP rule including a first RSD having a capability validity field with a single RAT indication, such as LTE, then the dual-steer layer 315 may determine that the first RSD is valid for the protocol stack 305 (the protocol stack that is associated with the URSP rules 392) only if the protocol stack 305 supports LTE. In this case, the dual-steer layer 315 may use the first RSD to manage routing of data traffic at the protocol stack 305. In this example, if the protocol stack 305 does not support LTE, then the first RSD might not be used to manage routing of data traffic at the protocol stack 305.

In the case where the capability validity field of an RSD is empty, e.g., does not indicate any RAT, the dual-steer layer 315 may use the associated RSD to route traffic irrespective of the RAT associated with protocol stack for which the associated URSP applies. For instance if URSP rules 394, received at and associated with the protocol stack 310, includes a first URSP rule including a first RSD having a capability validity field that is empty, then the dual-steer layer 315 may determine that the first RSD is valid for the protocol stack 310 (the protocol stack that is associated with the URSP rules 394) irrespective of the RAT supported by the protocol stack 310. In this case, the dual-steer layer 315 may use the first RSD to manage routing of data traffic at the protocol stack 310.

When an RSD of one or more of the URSP rules is identified as valid by the dual-steer layer 315, the dual-steer layer 315 may use the preferred access type field of the RSD to determine how or where to route the traffic. The preferred access type field of the RSD may provide an indication of whether the dual-steer layer 315 should perform single steering (e.g., steer the data traffic to a single protocol stack) or dual-steering (e.g., steer the data traffic to multiple protocol stacks) when the conditions specified by the RSD are satisfied (e.g., when the RSD is determined to be valid). For instance, when the preferred access type field indicates that single steering should be performed (e.g., when the preferred access field has a value of “3GPP”), then the dual-steer layer 315 may steer or route the data traffic to the protocol stack associated with the corresponding URSP rule.

For instance, a simplified structure of the URSP rules 392 and URSP rules 394 are shown below in Tables 1 and 2.

TABLE 1
URSP Rules 392

| URSP | Traffic | | Capability | |
|---|---|---|---|---|
| Rules | Descriptor | RSDs | Validity | Preferred Access Type |
| Rule 1 | App A | RSD1 | NR_LTE | Dual-steering |
| Rule 1 | App A | RSD2 | NR_NR | 3GPP |
| Rule 1 | App A | RSD3 | LTE_LTE | 3GPP |
| Rule 1 | App A | RSD4 | | 3GPP |
| Rule 2 | App B | RSD4 | | 3GPP |

Referring to Table 1, URSP rules 392 may be received at the protocol stack 305. The URSP rules 392 may be used by the dual-steer layer 315 for routing decisions at the protocol stack 305. The URSP rules 392 may include a first URSP rule, e.g., Rule 1, that may be applicable when the data traffic associated with App A (e.g., one of the applications 330) is to be routed, and a Rule 2 that may be applicable when data traffic associated with App B (e.g., one of the applications 330) is to be routed. Accordingly, the dual-steer layer 315 may determine that RSD1 is valid for routing App A traffic if the protocol stacks 305 and 310 support a combination of NR and LTE RATs. If the protocol stacks 305 and 310 both support NR RAT, then the dual-steer layer 315 may determine that RSD2 is valid for routing App A traffic. If the protocol stacks 305 and 310 both support LTE RAT, then the dual-steer layer 315 may determine that RSD3 is valid for routing App A traffic. In this example, the dual-steer layer 315 may also determine that RSD4 is valid for routing App A traffic, irrespective of the RATs supported by protocol stacks 305 and 310. Accordingly, if the dual-steer layer 315 determines that RSD1 is valid for App A traffic, the dual-steer layer 315 may determine to perform dual-steering to route the App A traffic. That is, the dual-steer layer 315 may route the App A traffic using both the protocol stack 305 and the protocol stack 310. If the dual-steer layer 315 determines RSD2, RSD3, or RSD4 to be valid for App A traffic, the dual-steer layer 315 may route the App A traffic using single steering. That is, only a single protocol stack, such as the protocol stack 305 that is associated with the URSP rules 392 may be used for routing the App A traffic in this case. The dual-steer layer 315 may make similar determinations about the validity of an RSD for the data traffic associated with App B.

In some cases when more than one RSD is determined to be valid for a particular type of data traffic and the RSDs indicate different preferred access types, a priority indicator (not shown) associated with the RSD may be used to determine which RSD to use. For instance, the dual-steer layer 315 may select the RSD with the highest priority to use to route the data traffic for that type of data traffic.

TABLE 2
URSP Rules 394

| URSP | Traffic | | Capability | |
|---|---|---|---|---|
| Rules | Descriptor | RSDs | Validity | Preferred Access Type |
| Rule 1 | App B | RSD1 | NR_LTE | Dual-steering |
| Rule 1 | App B | RSD5 | LTE | 3GPP |
| Rule 2 | App C | RSD4 | | 3GPP |

Referring to Table 2, URSP rules 394 may be received at the protocol stack 310. The URSP rules 394 may be used by the dual-steer layer 315 for routing decisions at the protocol stack 310. The URSP rules 394 may include a first URSP rule, e.g., Rule 1, that may be applicable when the data traffic associated with App B (e.g., one of the applications 330) is to be routed, and a Rule 2 that may be applicable when data traffic associated with App C (e.g., one of the applications 330) is to be routed.

Accordingly, the dual-steer layer 315 may determine that RSD1 is valid for routing App B traffic if the protocol stacks 305 and 310 support a combination of NR and LTE RATs. The dual-steer layer 315 may determine that RSD5 is valid for routing App B traffic if protocol stack 310 supports LTE. Accordingly, if the dual-steer layer 315 determines that RSD1 is valid for App B traffic, the dual-steer layer 315 may determine to perform dual-steering to route the App B traffic. That is, the dual-steer layer 315 may route the App B traffic using both the protocol stack 310 and the protocol stack 305. If the dual-steer layer 315 determines RSD5 to be valid for App B traffic, the dual-steer layer 315 may route the App B traffic using single steering. That is, the protocol stack 310 associated with the URSP rules 394 may be used for routing the App B traffic in this case. The dual-steer layer 315 may make similar determinations about the validity of an RSD for the data traffic associated with App C.

Accordingly, when the URSP rules 392 and 394 are transmitted independently to each of the protocol stacks 305 and 310, when the dual-steer layer 315 processes the URSP rules at each of the protocol stacks, if the dual-steer layer 315 identifies a valid RSD that includes an indication to perform single steering, the dual-steer layer 315 uses the protocol stack associated with the corresponding URSP rule. That is, valid single steering URSP rules on protocol stack 305 may result in routing via protocol stack 305, while valid single steering URSP rules on protocol stack 310 may result in routing via protocol stack 310.

In some cases, when the dual-steer layer 315 determines that dual-steering is to be performed, each of the protocol stacks 305 and 310 may be triggered to establish a PDU session (e.g., establish a new or updated PDU session or, in some cases, use an existing PDU session) with the core network 130-a. In this case, each of the protocol stacks 305 and 310 may initiate (e.g., establish a new or updated PDU session or, in some cases, use an existing PDU session) a PDU session, such as PDU sessions 395 and 397, respectively. Additionally, each of the protocol stacks 305 and 310 may transmit, to the core network 130-b, a PDU session establishment request. The PDU session establishment request may include information identifying the protocol stack and the corresponding PDU session associated with the counterpart protocol stack. For instance, a PDU session establishment request transmitted by the protocol stack 305 to the core network 130-b may include information identifying the protocol stack 310 and corresponding PDU session 397. For instance, the PDU session establishment request from the protocol stack 305 may include an indication of a Subscription Permanent Identifier (SUPI) associated with the protocol stack 310 and a PDU session identifier associated with the PDU session 397. Similarly, a PDU session establishment request transmitted by the protocol stack 310 to the core network 130-b may include information identifying the protocol stack 305 and corresponding PDU session 395. For instance, the PDU session establishment request from the protocol stack 310 may include an indication of a SUPI associated with the protocol stack 305 and PDU session identifier associated with the PDU session 395.

The core network 130-b may receive the PDU session establishment requests from the protocol stacks 305 and 310 and may determine to associate (e.g., bind) the requested PDU session to the corresponding protocol stack. For instance, the core network 130-b may bind the PDU session 395 to the protocol stack 305 and may bind the PDU session 397 to protocol stack 310. The core network 130-b may additionally associate or bind the PDU session 395 and the PDU session 397 to coordinate the dual-steering at the UE 115-b.

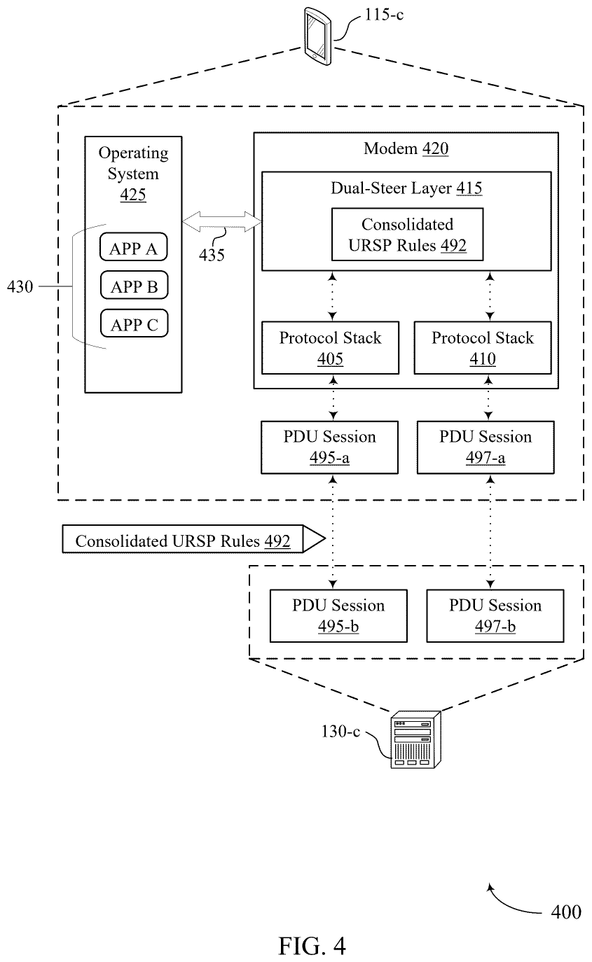

FIG. 4 shows an example of a block diagram 400 of a UE 115-c and a core network 130-c that support dual-steering operations for wireless communications in accordance with one or more aspects of the present disclosure. In some examples, the UE 115-c and the core network 130-c may implement or be implemented by aspects of the wireless communications system 100 and the wireless communications system 200, as described with reference to FIGS. 1 and 2, respectively. The UE 115-c may be an example of UE 115, UE 115-a, or UE 115-b, as described with reference to FIGS. 1, 2, and 3, respectively. The core network 130-c may be an example of core network 130, core network 130-a, or core network 130-b, as described with reference to FIGS. 1, 2, and 3, respectively.

The UE 115-c may include an operating system 425 and a modem 420. The operating system 425 may support one or more applications 430. The operating system 425 may be an example of the operating systems 225 or 325, as described with reference to FIGS. 2 and 3. The modem 420 may interface with the operating system 425, via the data interface 435, to receive and transmit data traffic associated with the one or more applications 430. The modem 420 may be an example of modems 220 or 320, as described with reference FIGS. 2 and 3.

The modem 420 may be configured with multiple subscriptions (such as via multiple SIMs) and corresponding protocol stacks to support one or multiple wireless services over one or more access networks, such as described with reference to FIGS. 1, 2, and 3. For example, the UE 115-c may be configured with a protocol stack 405 and a protocol stack 410, which may be examples of protocol stacks 205 and 210 or protocol stacks 305 and 310, as described with reference to FIGS. 2 and 3.

The modem 420 may additionally be configured to support dual-steering and may be configured with a dual-steer layer 415, which may be an example of dual-steer layers 215 or 315 as described with reference to FIGS. 2 and 3. The dual-steer layer 415 may be configured to route or steer data traffic received from the operating system 425, via the data interface 435, to one or more of the protocol stacks 405 and 410. The data may be routed from one or more of the protocol stacks 405 and 410 and to the core network 130-c via one or more corresponding PDU sessions 495 (e.g., PDU session 495-a and PDU session 495-b) and 497 (e.g., PDU session 497-a and PDU session 497-b).

In some cases, the UE 115-c may transmit an indication of its dual-steering capabilities to the core network 130-c. For instance, one or more of the protocol stacks 405 and 410 of the UE 115-c may transmit, via one or more of the PDU sessions 495 and 497 (or in some cases via a corresponding access network), signaling comprising an indication of the dual-steering capabilities of the protocol stack. In some cases, the signaling may comprise additional information, such as information identifying a quantity of subscriptions or protocol stacks for which the UE 115-c is configured, or information related to other capabilities of the UE 115-c. In some cases. the information indicating the dual-steering information and the additional information may be provided to the core network 130-c as part of a process where one or more of the protocol stacks 405 and 410 of the UE 115-c register with the core network 130-c. That is, the protocol stacks 405 and 410 of the UE 115-e may register with the core network 130-c to obtain access to wireless services associated with the core network 130-c. To register with the network, the protocol stacks 405 and 410 of may perform a registration procedure, which may include exchange of signaling (e.g., information) with one or more of the corresponding access networks or the core network 130-c.

In response to receiving the information indicating the dual-steering capabilities of the UE 115-c or one or more of the protocol stacks 405 and 410, the core network 130-c may transmit to the UE 115-c, via one of the PDU sessions 495 or 497, a single set of URSP rules. The single set of URSP rules may be a consolidate set of URSP rules that may apply to each of the protocol stacks of the UE 115-c. The core network 130-c may transmit the consolidated URSP rules 492. The consolidated URSP rules 492 may be transmitted to a single protocol stack (instead of transmitting independent sets of URSP rules to each of the protocol stacks, as described with reference to FIG. 3). For instance, in the example of FIG. 4, the core network 130-c may transmit consolidated URSP rules 492 via the PDU session 495 to protocol stack 405. The core network 130-c may send the consolidated URSP rules 492 to the UE 115-c when the URSP rules are applicable to each of the protocol stacks of the UE 115-c. In this case, the dual-steer layer 415 may obtain (e.g., receive) the consolidated URSP rules 492 from the protocol stack 405 and may use the consolidated URSP rules 492 to make routing decisions associated with both the protocol stacks 405 and 410.

The consolidated URSP rules 492 may be similar to the URSP rules 392 and 394 described with respect to FIG. 3. For instance, each of the consolidated URSP rules 492 may include a traffic descriptor identifying a type of data traffic (such as information identifying traffic from a particular one of the applications 430) and a mapping to one or more RSDs that indicate where or how to route the corresponding type of data traffic (as indicated by the traffic identifier) when certain conditions are met. Each RSD may include one or more parameters or fields that provide the indications of where or how to route the corresponding type of data traffic and the conditions that are to be met in order to trigger such routing. In some cases, when the URSP rules, such as the consolidated URSP rules 492, are applicable to multiple protocol stacks, the RSDs may be configured with an additional field, such as a subscription validity field that may indicate which protocol stack (e.g., which subscriber) data traffic should be routed to in the case of a valid RSD.

For instance, a simplified structure of the consolidated URSP rules 492, including the subscriber validity field, is shown below in Table 3.

TABLE 3
Consolidated URSP Rules 492

| URSP | Traffic | | Capability | Preferred | Subscription |
|---|---|---|---|---|---|
| Rules | Descriptor | RSDs | Validity | Access Type | Validity |
| Rule 1 | App A | RSD1 | NR_LTE | Dual- | |
| | | | | steering | |
| Rule 1 | App A | RSD2 | NR_NR | 3GPP | Protocol |
| | | | | | Stack 1 |
| Rule 1 | App A | RSD3 | LTE_LTE | 3GPP | Protocol |
| | | | | | Stack 1 |
| Rule 1 | App A | RSD4 | | 3GPP | Protocol |
| | | | | | Stack 1 |
| Rule 1 | App A | RSD5 | LTE | 3GPP | Protocol |
| | | | | | Stack 2 |
| Rule 2 | App B | RSD4 | | 3GPP | Protocol |
| | | | | | Stack 1 |
| Rule 3 | App C | RSD6 | | 3GPP | Protocol |
| | | | | | Stack 2 |

Referring to Table 3, consolidated URSP rules 492 may be received at the protocol stack 405 and may be sent to the dual-steer layer 415 for processing. The consolidated URSP rules 492 may be used by the dual-steer layer 415 for routing decisions at the both the protocol stacks 405 and 410. The consolidated URSP rules 492 may include a first URSP rule, e.g., Rule 1, that may be applicable when the data traffic associated with App A (e.g., one of the applications 430) is to be routed, a Rule 2 that may be applicable when data traffic associated with App B (e.g., one of the applications 430) is to be routed, and a Rule 3 that may be applicable when data traffic associated with App C (e.g., one of the applications 430) is to be routed.

Accordingly, the dual-steer layer 415 may determine that RSD1 is valid for routing App A traffic if the protocol stacks 405 and 410 support a combination of NR and LTE RATs. If the protocol stacks 405 and 410 both support NR RAT, then the dual-steer layer 415 may determine that RSD2 is valid for routing App A traffic. If the protocol stacks 405 and 410 both support LTE RAT, then the dual-steer layer 415 may determine that RSD3 is valid for routing App A traffic. The dual-steer layer 415 may further determine that RSD4 is valid for routing App A traffic, irrespective of the RATs supported by protocol stacks 405 and 410. In the case of RSD5, which includes a single RAT in the capability validity field, the dual-steer layer 415 may determine RSD5 to be valid for routing App A traffic if the protocol stack indicated by the subscription validity field supports LTE.

Accordingly, if the dual-steer layer 415 determines that RSD1 is valid for App A traffic, the dual-steer layer 315 may determine to perform dual-steering to route the App A traffic. That is, the dual-steer layer 415 may route the App A traffic using both the protocol stack 405 and the protocol stack 410. If the dual-steer layer 415 determines RSD2, RSD3, RSD4, or RSD5 to be valid for App A traffic, the dual-steer layer 415 may route the App A traffic using single steering (such as indicated by the 3GPP value of the preferred access type field). That is, only a single protocol stack may be used for routing the App A traffic. In this case, the subscription validity field may be used to identify which of the protocol stacks to use to route the data. For instance, in the case that RSD2, RSD3, or RSD4 are determined to be valid for App A traffic, the traffic may be routed via Protocol Stack 1, which may correspond to protocol stack 405, for example. In the case that RSD5 is determined to be valid for App A traffic, the traffic may be routed via Protocol Stack 2, which may correspond to protocol stack 410. The dual-steer layer 415 may make similar determinations about the validity of an RSD for the data traffic associated with App B and App C.

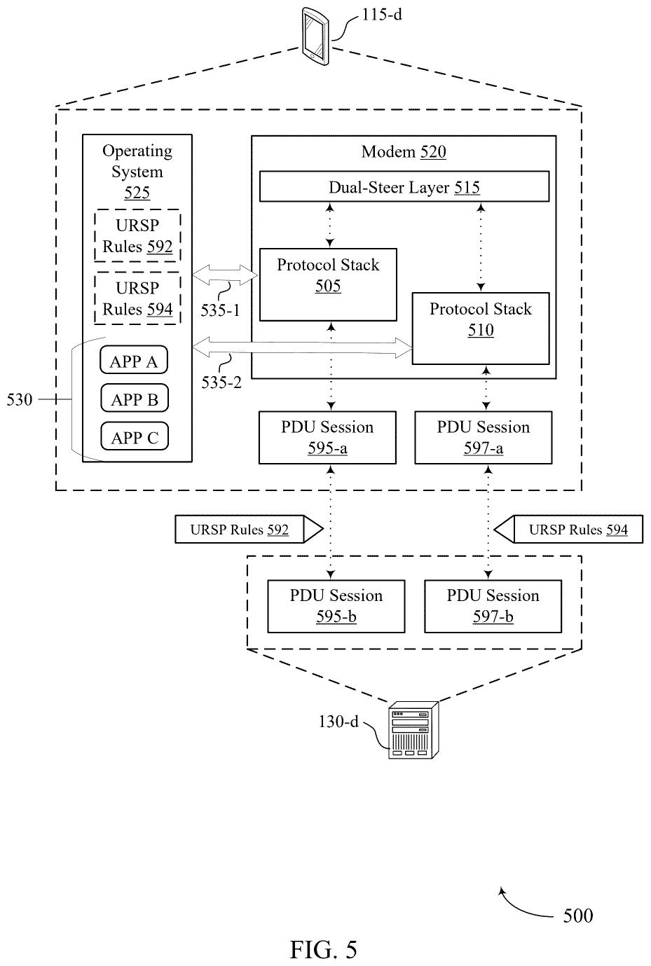

FIG. 5 shows an example of a block diagram 500 of a UE 115-d and a core network 130-d that support dual-steering operations for wireless communications in accordance with one or more aspects of the present disclosure. In some examples, the UE 115-d and the core network 130-d may implement or be implemented by aspects of the wireless communications system 100 and the wireless communications system 200, as described with reference to FIGS. 1 and 2, respectively. The UE 115-d may be an example of UE 115, UE 115-a, UE 115-b, or UE 115-c, as described with reference to FIGS. 1, 2, 3, and 4, respectively. The core network 130-d may be an example of core network 130, core network 130-a, core network 130-b, or core network 130-c, as described with reference to FIGS. 1, 2, 3, and 4, respectively.

The UE 115-d may include an operating system 525 and a modem 520. The operating system 525 may support one or more applications 530. The operating system 525 may be an example of the operating systems 225, 325, or 425, as described with reference to FIGS. 2, 3, and 4. The modem 520 may interface with the operating system 525, via the data interface 535-1, 535-2, or a combination thereof, to receive and transmit data traffic associated with the one or more applications 530. The modem 520 may be an example of modems 220, 320, or 420, as described with reference FIGS. 2, 3, and 4.

The modem 520 may be configured with multiple subscriptions (such as via multiple SIMs) and corresponding protocol stacks to support one or multiple wireless services over one or more access networks, such as described with reference to FIGS. 1, 2, 3, and 4. For example, the UE 115-d may be configured with a protocol stack 505 and a protocol stack 510, which may be examples of protocol stacks 205 and 210, protocol stacks 305 and 310, or protocol stacks 405 and 410 as, described with reference to FIGS. 2, 3, and 4.

The modem 520 may additionally be configured to support dual-steering and may be configured with a dual-steer layer 515, which may be an example of dual-steering layers 215, 315, or 415, as described with reference to FIGS. 2, 3, and 4. The dual-steering layer 515 may be configured to route or steer data traffic received from the operating system 525, via one or more of the data interfaces 535-1 or 535-2, to one or more of the protocol stacks 505 and 510. The data may be routed from one or more of the protocol stacks 505 and 510 and to the core network 130-d via one or more corresponding PDU sessions 595 (e.g., PDU session 595-a and PDU session 595-b) and 597 (e.g., PDU session 597-a and PDU session 597-b).

In some cases, the UE 115-d may transmit an indication of its dual-steering capabilities to the core network 130-d. For instance, one or more of the protocol stacks 505 and 510 of the UE 115-d may transmit, via one or more of the PDU sessions 595 and 495 (or in some cases via a corresponding access network), signaling comprising an indication of the dual-steering capabilities of one or more of the protocol stack 505 and 510.

In response to receiving the information indicating the dual-steering capabilities of the UE 115-d or one or more of the protocol stacks 505 and 510, the core network 130-d may transmit to the UE 115-d, via one of the PDU sessions 595 or 495. In some cases, rather than managing the routing and steering of the data traffic from the operating system 525 in accordance with the URSP rules 592 and 594, the dual-steering layer 515, may alternatively inform (e.g., transmit or send) the operating system 525 of the URSP rules 592 and 594 and the operating system 525 may control routing or steering of the data traffic in accordance with the URSP rules 592 and 594 and using the data interfaces 535-1 and 535-2 that interface with the protocol stack 505 and the protocol stack 510, respectively.

For instance, in some cases, the dual-steering layer 515 may provide to the operating system 525 with the URSP rules 592 and 594, and the operating system 525 make routing decisions in the manner described with respect to FIGS. 2-4. Alternatively, the dual-steering layer 515 might not provide the operating system 525 with the URSP rules 592 and 594, and may instead provide the operating system 525 with routing decisions determined by the dual-steering layer 515. Based on the routing decisions (determined by the operating system 525 or the dual-steering layer 515), the operating system 525 may use one or more of the data interfaces 535-1 and 535-2 to route the data traffic to the appropriate protocol stack. For instance, data interface 535-1 may interface with protocol stack 505 and may be used to route data traffic to protocol stack 505. Data interface 535-2 may interface with protocol stack 510 and may be used to route data traffic to protocol stack 510. In some cases, both data interfaces 535-1 and 535-2 may be used concurrently to route data traffic, such as in the case where the URSP rules 592 or 594 indicate that dual-steering is to be performed.

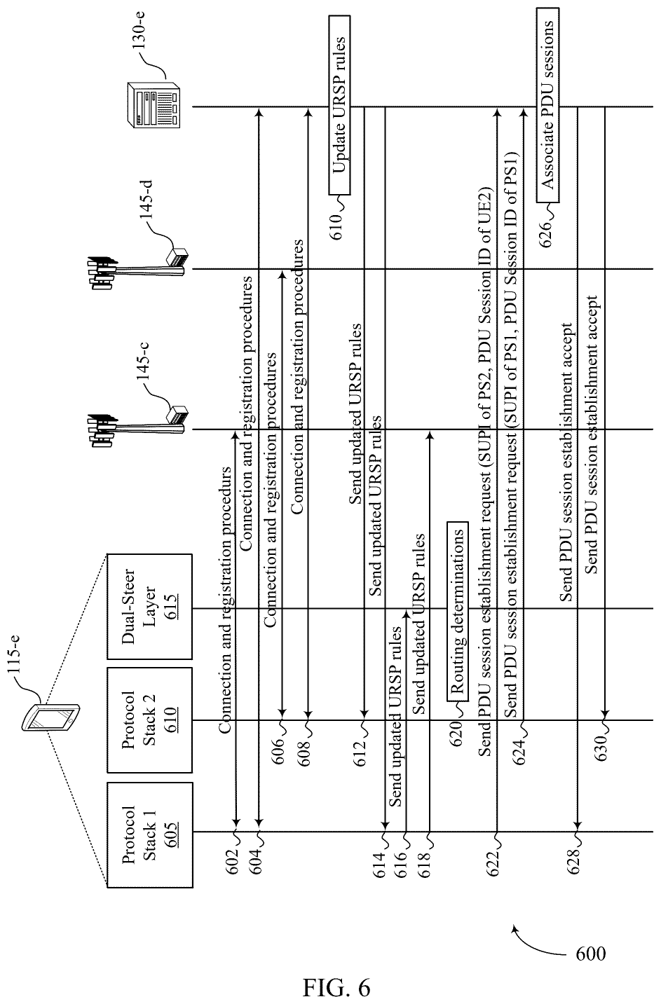

FIG. 6 shows an example of a process flow 600 that supports dual-steering operations for wireless communications in accordance with one or more aspects of the present disclosure. The process flow 600 may implement aspects of the wireless communications systems 100 and 200, as described with reference to FIGS. 1 and 2, respectively. The process flow 600 may include a UE 115-e and access networks 145-c and 145-d, which may be examples of as the corresponding devices described herein. The UE 115-e may include a protocol stack 1 605, a protocol stack 2 610, and a dual-steer layer 615, as described herein with reference to FIGS. 1 through 5. the process flow 600 may additionally include a core network 130-e, which may be an example core networks 130 as described herein.

In the following description of the process flow 600, the operations between the UE 115-e, the access networks 145-c and 145-d, and the core network 130-e may be transmitted in a different order than the example order shown, or the operations may be performed in different orders or at different times. Some operations may also be omitted from the process flow 600, and other operations may be added to the process flow 600.

At 602 and 604, the protocol stack 1 605 of the UE 115-e may perform one or more procedures to connect and register with one or more of the access network 145-c and the core network 130-e. The connection and registration procedures may include an exchange of signaling (e.g., information) with one or more of the access network 145-c and the core network 130-e. In some cases, the signaling may include an indication of dual-steering capabilities of the UE 115-e or the protocol stack 1 605 of the UE 115-e.

At 606 and 608, the protocol stack 2 610 of the UE 115-e may perform one or more procedures to connect and register with one or more of the access network 145-d and the core network 130-e. The connection and registration procedures may include an exchange of signaling (e.g., information) with one or more of the access network 145-d and the core network 130-e. In some cases, the signaling may include an indication of dual-steering capabilities of the UE 115-e or the protocol stack 2 610 of the UE 115-e.

At 610, based on receiving the indication of the capability of the UE 115-e or one or more of protocol stacks 605 and 610, the core network 130-e may update one or more URSP rules associated with the UE 115-e or one or more of protocol stacks 605 and 610. The updated URSP rules may be configured to support the dual-steering capabilities of the UE 115-e or the one or more of the protocol stacks 605 and 610 of the UE 115-e.

At 612 and 614, the core network 130-e may transmit or send the updated URSP rules to the UE 115-e, such as via one or more of the protocol stacks 605 and 610, respectively. In some cases, the core network 130-e may send URSP rules to each of the one or more protocol stacks 605 and 610. In other cases, the core network 130-e may send a single consolidate set of URSP rules to one of the protocol stacks 605 and 610.

At 616 and 618, in some cases, the dual-steer layer 615 of the UE 115-e, which may be responsible for managing the routing of data traffic in accordance with the rules, may obtain (e.g., receive) the URSP rules from one or more of the protocol stacks 605 and 610.

At 620, the dual-steer layer 615 may make routing determinations based on the URSP rules and traffic information associated with data traffic.

At 622 and 624, one or more of the protocol stacks 605 and 610 may send a PDU session establishment request to the to the core network 130-e. In some cases, the PDU session establishment requests may be sent in response to a determination (at 620) by the dual-steer layer 615 that dual-steering is to be performed to route data traffic to one or more of the protocol stacks 605 and 610. The PDU session establishment request may include information identifying the protocol stack and the corresponding PDU session associated with the counterpart protocol stack. For instance, each PDU session establishment request may include an indication of a SUPI associated with the counterpart protocol stack and a PDU session identifier associated with the PDU session of the counterpart protocol stack. In some cases, when a first PDU session establishment request is received from the protocol stack 1 605, the core network 130-e may not be aware of an upcoming second PDU session from the protocol stack 2 610. In this case, the core network 130-e may ignore the dual-steer information provided by the first PDU session establishment request, and at a later time, when the second PDU session establishment request is received by the core network 130-e, the core network 130-e may proceed to 626.

At 626, the core network 130-e, upon receiving the PDU session establishment requests, may associate or bind the PDU sessions associated with each of the PDU session establishment requests, so that the core network 130-e may be aware that the corresponding sessions are associated with a same UE 115-e.

At 628 and 630, the core network 130-e may, send to one or more of the protocol stack 1 605 and the protocol stack 2 610, an acknowledgement of acceptance of one or more of the PDU session establishment requests.

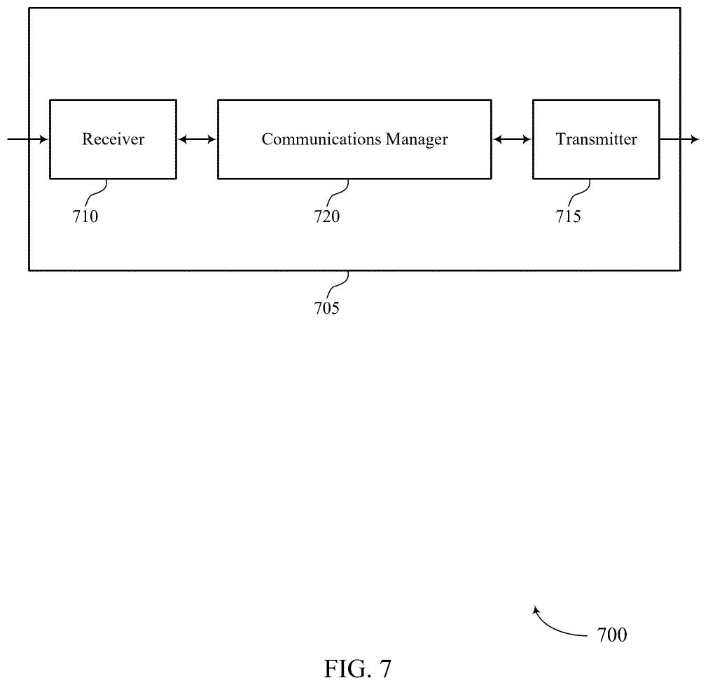

FIG. 7 shows a block diagram 700 of a device 705 that supports dual-steering operations for wireless communications in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to dual-steering operations for wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to dual-steering operations for wireless communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of dual-steering operations for wireless communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for transmitting, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions. The communications manager 720 is capable of, configured to, or operable to support a means for receiving, based on the capability of the UE, a first set of URSP rules for steering the data traffic associated with the UE. The communications manager 720 is capable of, configured to, or operable to support a means for routing, via a higher layer of the UE based at least in part on the first set of URSP rules and on the capability of the UE, the data traffic associated with the UE via one or both of the first protocol stack or the second protocol stack.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing and more efficient utilization of communication resources.

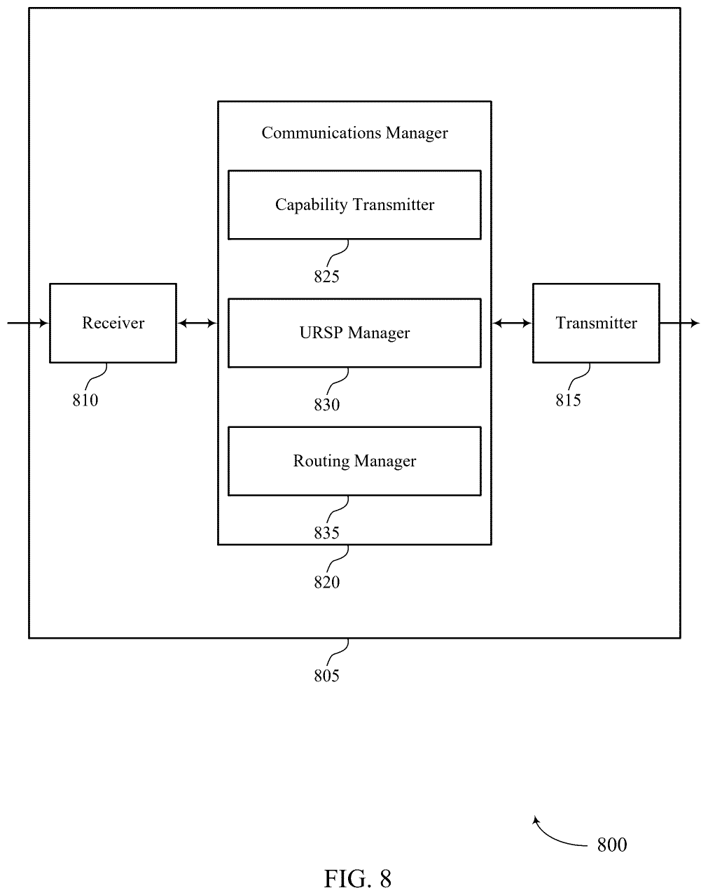

FIG. 8 shows a block diagram 800 of a device 805 that supports dual-steering operations for wireless communications in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to dual-steering operations for wireless communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to dual-steering operations for wireless communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of dual-steering operations for wireless communications as described herein. For example, the communications manager 820 may include a capability transmitter 825, an URSP manager 830, a routing manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The capability transmitter 825 is capable of, configured to, or operable to support a means for transmitting, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions. The URSP manager 830 is capable of, configured to, or operable to support a means for receiving, based on the capability of the UE, a first set of URSP rules for steering the data traffic associated with the UE. The routing manager 835 is capable of, configured to, or operable to support a means for routing, via a higher layer of the UE based on the first set of URSP rules and on the capability of the UE, the data traffic associated with the UE via one or both of the first protocol stack or the second protocol stack.

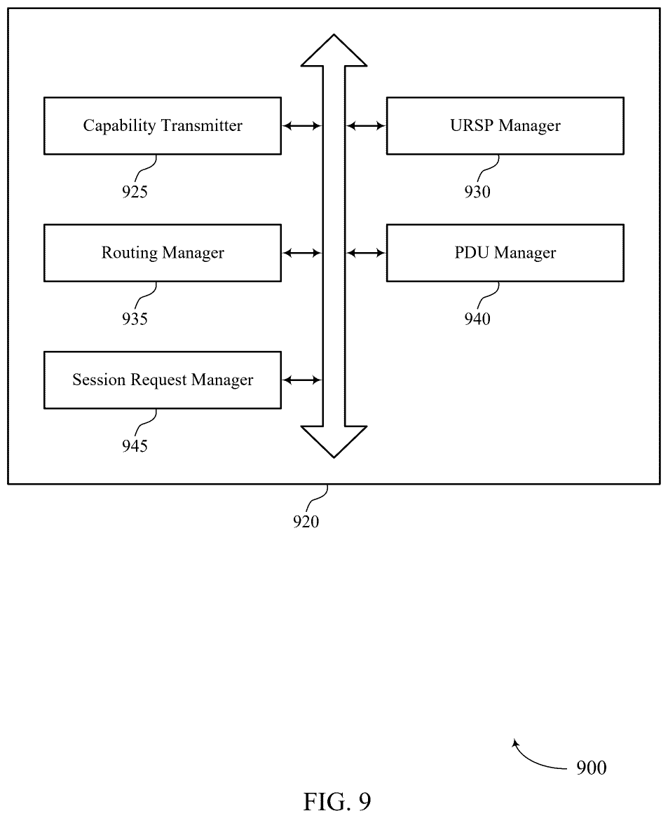

FIG. 9 shows a block diagram 900 of a communications manager 920 that supports dual-steering operations for wireless communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of dual-steering operations for wireless communications as described herein. For example, the communications manager 920 may include a capability transmitter 925, an URSP manager 930, a routing manager 935, a PDU manager 940, a session request manager 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The capability transmitter 925 is capable of, configured to, or operable to support a means for transmitting, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions. The URSP manager 930 is capable of, configured to, or operable to support a means for receiving, based on the capability of the UE, a first set of URSP rules for steering the data traffic associated with the UE. The routing manager 935 is capable of, configured to, or operable to support a means for routing, via a higher layer of the UE based on the first set of URSP rules and on the capability of the UE, the data traffic associated with the UE via one or both of the first protocol stack or the second protocol stack.

In some examples, the first set of URSP rules is received via the first protocol stack, and the URSP manager 930 is capable of, configured to, or operable to support a means for receiving, via the second protocol stack and based on the capability of the UE, a second set of URSP rules for steering the data traffic, where the first set of URSP rules is associated with the first protocol stack and the second set of URSP rules is associated with the second protocol stack.

In some examples, the first set of URSP rules is received via the higher layer of the UE and is associated with both the first protocol stack and the second protocol stack.

In some examples, to support each RSD of the set of RSDs, the URSP manager 930 is capable of, configured to, or operable to support a means for a preferred access type indicating whether to perform single steering or dual-steering. In some examples, to support each RSD of the set of RSDs, the URSP manager 930 is capable of, configured to, or operable to support a means for a validity field indicating one or more RAT capabilities corresponding to one or more of the first protocol stack, the second protocol stack, the first subscription, or the second subscription, or any combination thereof.

In some examples, to support routing the data traffic via one or both of the first protocol stack or the second protocol stack, the routing manager 935 is capable of, configured to, or operable to support a means for routing the data traffic based on a first URSP rule, the first URSP rule based on traffic information associated with the data traffic and one or more traffic descriptors associated with one or more URSP rules of the first set of URSP rules.

In some examples, to support routing the data traffic based on the first URSP rule, the routing manager 935 is capable of, configured to, or operable to support a means for routing the data traffic via both the first protocol stack and the second protocol stack based on the preferred access type associated with a first RSD associated with the first URSP rule for use in routing the data traffic, the first RSD based on a capability of one or both of the first protocol stack and the second protocol stack and one or more validity indicators associated with one or more RSDs associated with the first URSP rule.

In some examples, to support routing the data traffic based on the first URSP rule, the routing manager 935 is capable of, configured to, or operable to support a means for routing the data traffic via one of the first protocol stack or the second protocol stack based on the preferred access type associated with a first RSD associated with the first URSP rule for use in routing the data traffic, the first RSD based on a capability associated with one or both of the first protocol stack and the second protocol stack and one or more validity indicators associated with one or more RSDs associated with the first URSP rule.

In some examples, to support routing the data traffic based on the first URSP rule, the routing manager 935 is capable of, configured to, or operable to support a means for routing the data traffic via one of the first protocol stack or the second protocol stack based on a first RSD associated with the first URSP rule for use in routing the data traffic, the first RSD based on one RSD being associated with the first URSP rule and the validity indicator associated with the first RSD being empty.

In some examples, each RSD of the set of RSDs includes a subscription validity indicator identifying a protocol stack for routing the data traffic.

In some examples, to support routing the data traffic based on the first URSP rule, the routing manager 935 is capable of, configured to, or operable to support a means for routing the data traffic via the protocol stack identified by the subscription validity indicator associated with a first RSD based on the preferred access type associated with the first RSD indicating single steering, the first RSD associated with the first URSP rule for use in routing the data traffic and based on a capability of one or both of the first protocol stack and the second protocol stack and one or more validity indicators associated with one or more RSDs associated with the first URSP rule.

In some examples, to support routing the data traffic based on the first URSP rule, the routing manager 935 is capable of, configured to, or operable to support a means for routing the data traffic via one or both of the first protocol stack or the second protocol stack based on the subscription validity indicator associated with a first RSD associated with the first URSP rule for use in routing the data traffic being empty, the first RSD based on a capability of one or both of the first protocol stack and the second protocol stack and one or more validity indicators associated with one or more RSDs associated with the first URSP rule.

In some examples, to support routing the data traffic via one or both of the first protocol stack or the second protocol stack, the routing manager 935 is capable of, configured to, or operable to support a means for routing the data traffic via both of the first protocol stack or the second protocol stack.

In some examples, the PDU manager 940 is capable of, configured to, or operable to support a means for initiating, at the first protocol stack, a first PDU session. In some examples, the PDU manager 940 is capable of, configured to, or operable to support a means for initiating, at the second protocol stack, a second PDU session. In some examples, the session request manager 945 is capable of, configured to, or operable to support a means for transmitting, to a core network and via the first protocol stack, a first request to establish the first PDU session, where the first request indicates an identifier associated with the second protocol stack and an identifier associated with the second PDU session. In some examples, the session request manager 945 is capable of, configured to, or operable to support a means for transmitting, to the core network and via the second protocol stack, a second request to establish the second PDU session, where the second request indicates an identifier associated with the first protocol stack and an identifier associated with the first PDU session.

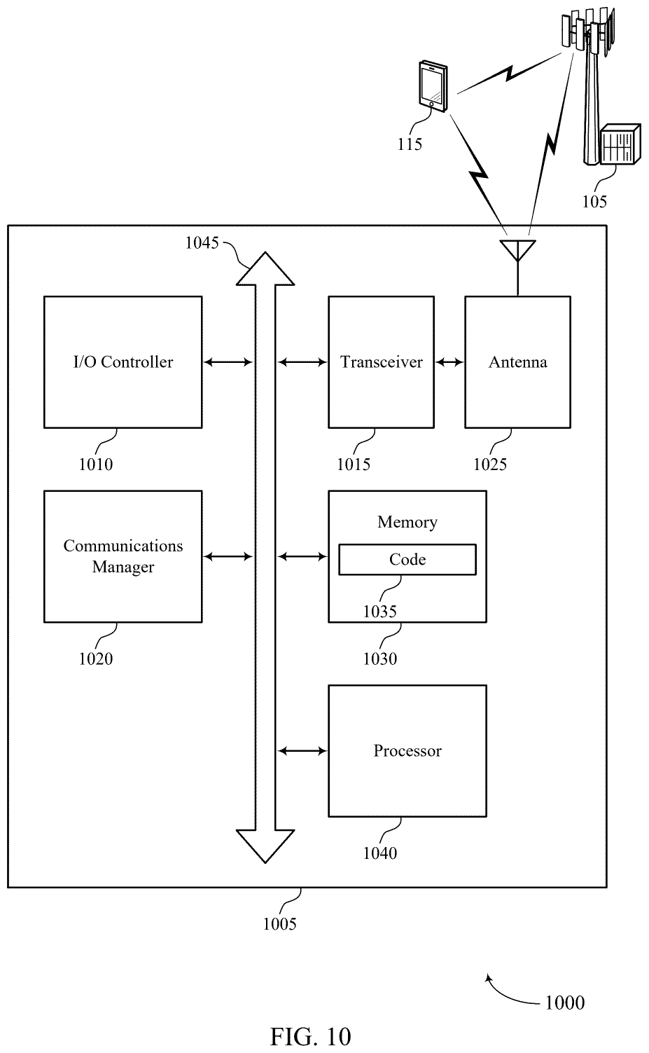

FIG. 10 shows a diagram of a system 1000 including a device 1005 that supports dual-steering operations for wireless communications in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting dual-steering operations for wireless communications). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for transmitting, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions. The communications manager 1020 is capable of, configured to, or operable to support a means for receiving, based on the capability of the UE, a first set of URSP rules for steering the data traffic associated with the UE. The communications manager 1020 is capable of, configured to, or operable to support a means for routing, via a higher layer of the UE based at least in part on the first set of URSP rules and on the capability of the UE, the data traffic associated with the UE via one or both of the first protocol stack or the second protocol stack.

By including or configuring the communications manager 1020 in accordance with examples as described herein, the device 1005 may support techniques for reduced latency, improved user experience related to reduced processing, more efficient utilization of communication resources, improved coordination between devices, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of dual-steering operations for wireless communications as described herein, or the at least one processor 1040 and the at least one memory 1030 may be otherwise configured to, individually or collectively, perform or support such operations.

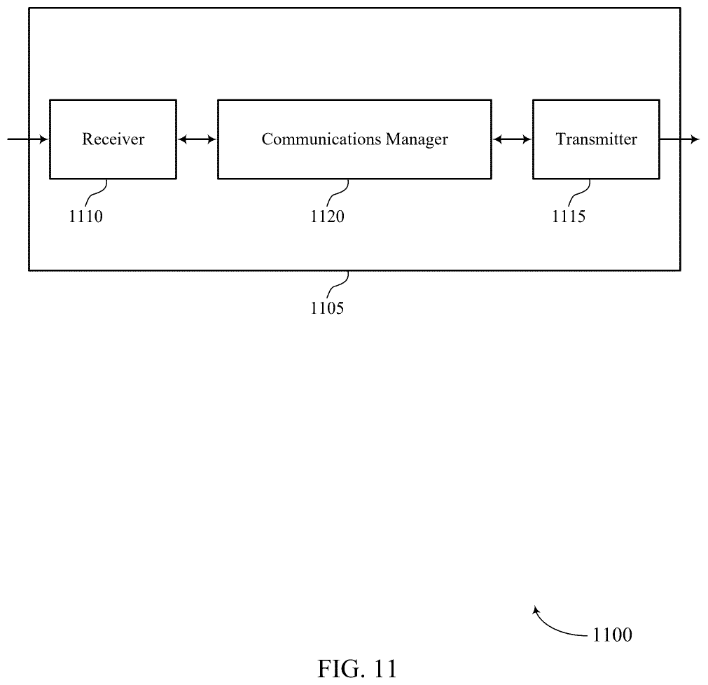

FIG. 11 shows a block diagram 1100 of a device 1105 that supports dual-steering operations for wireless communications in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of dual-steering operations for wireless communications as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for receiving, from a UE, an indication of a capability of the UE to steer data traffic associated with the UE via a set of multiple protocol stacks of the UE, where each protocol stack of the UE corresponds to a respective subscription of a set of multiple subscriptions of the UE. The communications manager 1120 is capable of, configured to, or operable to support a means for updating, basing at least in part on the capability of the UE, a first set of URSP rules to support a dual-steering functionality at the UE. The communications manager 1120 is capable of, configured to, or operable to support a means for transmitting, to the UE, the first set of URSP rules.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing and more efficient utilization of communication resources.

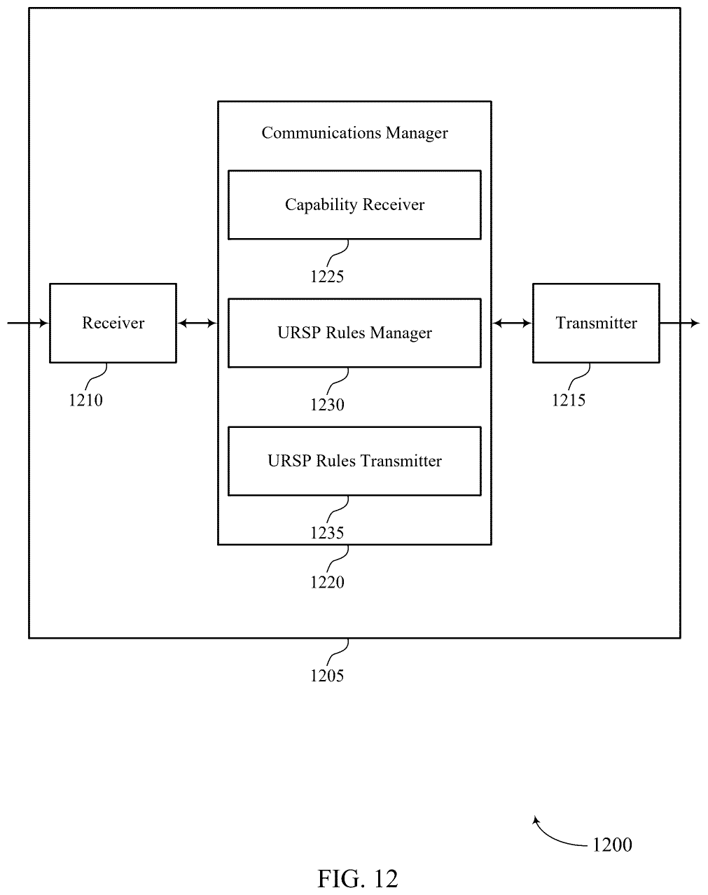

FIG. 12 shows a block diagram 1200 of a device 1205 that supports dual-steering operations for wireless communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of dual-steering operations for wireless communications as described herein. For example, the communications manager 1220 may include a capability receiver 1225, an URSP rules manager 1230, an URSP rules transmitter 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The capability receiver 1225 is capable of, configured to, or operable to support a means for receiving, from a UE, an indication of a capability of the UE to steer data traffic associated with the UE via a set of multiple protocol stacks of the UE, where each protocol stack of the UE corresponds to a respective subscription of a set of multiple subscriptions of the UE. The URSP rules manager 1230 is capable of, configured to, or operable to support a means for updating, based on the capability of the UE, a first set of URSP rules to support a dual-steering functionality at the UE. The URSP rules transmitter 1235 is capable of, configured to, or operable to support a means for transmitting, to the UE, the first set of URSP rules.

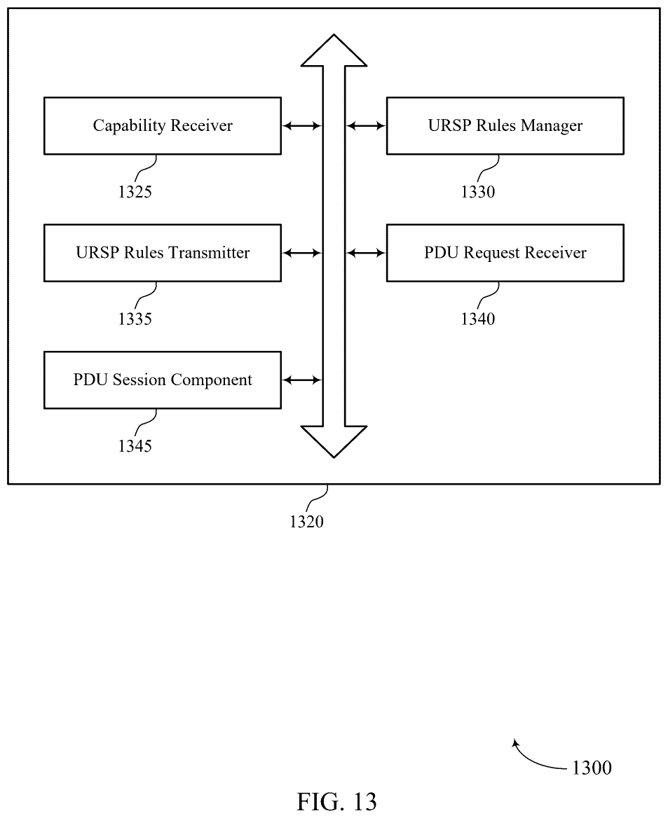

FIG. 13 shows a block diagram 1300 of a communications manager 1320 that supports dual-steering operations for wireless communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of dual-steering operations for wireless communications as described herein. For example, the communications manager 1320 may include a capability receiver 1325, an URSP rules manager 1330, an URSP rules transmitter 1335, a PDU request receiver 1340, a PDU session component 1345, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The capability receiver 1325 is capable of, configured to, or operable to support a means for receiving, from a UE, an indication of a capability of the UE to steer data traffic associated with the UE via a set of multiple protocol stacks of the UE, where each protocol stack of the UE corresponds to a respective subscription of a set of multiple subscriptions of the UE. The URSP rules manager 1330 is capable of, configured to, or operable to support a means for updating, based on the capability of the UE, a first set of URSP rules to support a dual-steering functionality at the UE. The URSP rules transmitter 1335 is capable of, configured to, or operable to support a means for transmitting, to the UE, the first set of URSP rules.

In some examples, the first set of URSP rules is associated with a first protocol stack of the set of multiple protocol stacks of the UE, and the URSP rules transmitter 1335 is capable of, configured to, or operable to support a means for transmitting, based on the capability of the UE, a second set of URSP rules to support the dual-steering functionality at the UE, where the second set of URSP rules is associated with a second protocol stack of the set of multiple protocol stacks of the UE.

In some examples, the first set of URSP rules is associated with the set of multiple protocol stacks of the UE.

In some examples, to support each RSD of the set of RSDs, the URSP rules manager 1330 is capable of, configured to, or operable to support a means for a preferred access type indicating whether to perform single steering or dual-steering. In some examples, to support each RSD of the set of RSDs, the URSP rules manager 1330 is capable of, configured to, or operable to support a means for a validity field indicating one or more RAT capabilities corresponding to one or more of a first protocol stack of the set of multiple protocol stacks, a second protocol stack of the set of multiple protocol stacks, a first subscription of the set of multiple subscriptions, or a second subscription of the set of multiple subscriptions, or any combination thereof.

In some examples, each RSD of the set of RSDs includes a subscription validity indicator identifying which protocol stack of the set of multiple protocol stacks of the UE to route traffic through.

In some examples, the PDU request receiver 1340 is capable of, configured to, or operable to support a means for receiving, from the UE, a first request to establish a first PDU session associated with a first protocol stack of the set of multiple protocol stacks of the UE, where the first request includes an indication of an identifier associated with a second protocol stack of the set of multiple protocol stacks of the UE and an identifier associated with a second PDU session associated with the second protocol stack.

In some examples, the PDU request receiver 1340 is capable of, configured to, or operable to support a means for receiving, from the UE, a second request to establish the second PDU session, where the second request includes an indication of an identifier associated with the first protocol stack and an identifier associated with the first PDU session.

In some examples, the PDU session component 1345 is capable of, configured to, or operable to support a means for associating, based on receiving the first request and the second request, the first PDU session and the second PDU session with the UE.

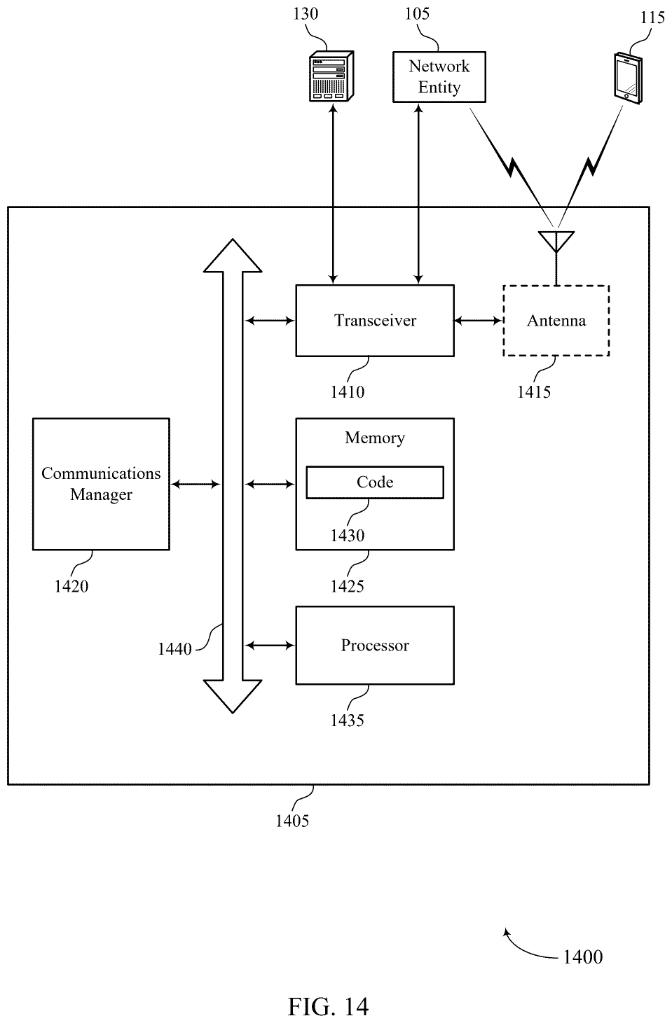

FIG. 14 shows a diagram of a system 1400 including a device 1405 that supports dual-steering operations for wireless communications in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting dual-steering operations for wireless communications). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for receiving, from a UE, an indication of a capability of the UE to steer data traffic associated with the UE via a set of multiple protocol stacks of the UE, where each protocol stack of the UE corresponds to a respective subscription of a set of multiple subscriptions of the UE. The communications manager 1420 is capable of, configured to, or operable to support a means for updating, basing at least in part on the capability of the UE, a first set of URSP rules to support a dual-steering functionality at the UE. The communications manager 1420 is capable of, configured to, or operable to support a means for transmitting, to the UE, the first set of URSP rules.

By including or configuring the communications manager 1420 in accordance with examples as described herein, the device 1405 may support techniques for improved user experience related to reduced processing, more efficient utilization of communication resources, improved coordination between devices, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of dual-steering operations for wireless communications as described herein, or the at least one processor 1435 and the at least one memory 1425 may be otherwise configured to, individually or collectively, perform or support such operations.

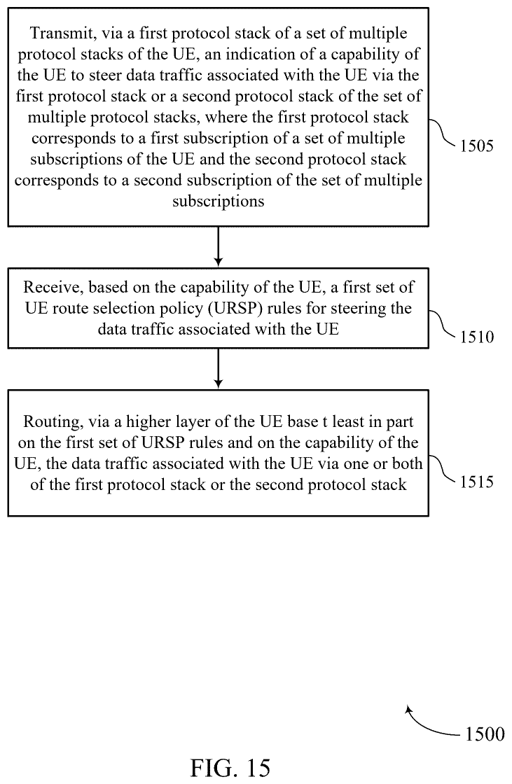

FIG. 15 shows a flowchart illustrating a method 1500 that supports dual-steering operations for wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions. The operations of 1505 may be performed in accordance with examples as disclosed herein. In some examples, aspects of the operations of 1505 may be performed by a capability transmitter 925 as described with reference to FIG. 9.

At 1510, the method may include receiving, based on the capability of the UE, a first set of URSP rules for steering the data traffic associated with the UE. The operations of 1510 may be performed in accordance with examples as disclosed herein. In some examples, aspects of the operations of 1510 may be performed by an URSP manager 930 as described with reference to FIG. 9.

At 1515, the method may include routing, via a higher layer of the UE based on the first set of URSP rules and on the capability of the UE, the data traffic associated with the UE via one or both of the first protocol stack or the second protocol stack. The operations of 1515 may be performed in accordance with examples as disclosed herein. In some examples, aspects of the operations of 1515 may be performed by a routing manager 935 as described with reference to FIG. 9.

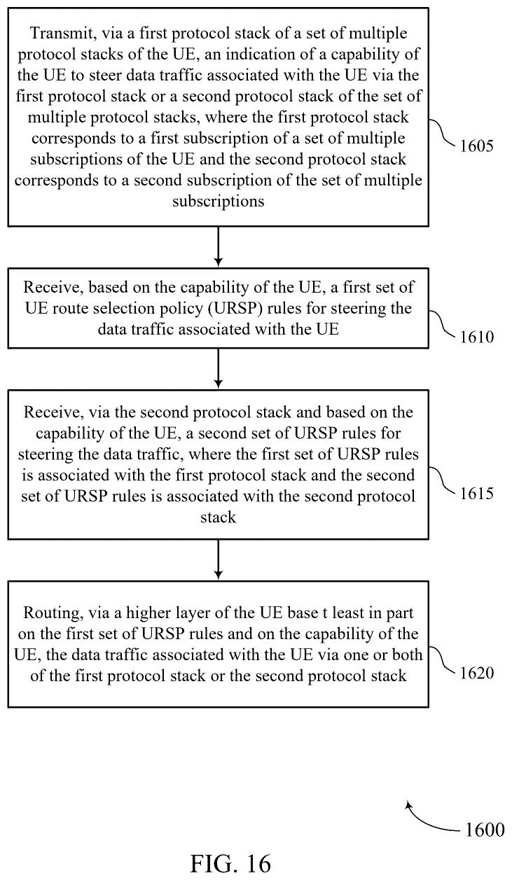

FIG. 16 shows a flowchart illustrating a method 1600 that supports dual-steering operations for wireless communications in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions. The operations of 1605 may be performed in accordance with examples as disclosed herein. In some examples, aspects of the operations of 1605 may be performed by a capability transmitter 925 as described with reference to FIG. 9.

At 1610, the method may include receiving, based on the capability of the UE, a first set of URSP rules for steering the data traffic associated with the UE. The operations of 1610 may be performed in accordance with examples as disclosed herein. In some examples, aspects of the operations of 1610 may be performed by an URSP manager 930 as described with reference to FIG. 9.

At 1615, the method may include receiving, via the second protocol stack and based on the capability of the UE, a second set of URSP rules for steering the data traffic, where the first set of URSP rules is associated with the first protocol stack and the second set of URSP rules is associated with the second protocol stack. The operations of 1615 may be performed in accordance with examples as disclosed herein. In some examples, aspects of the operations of 1615 may be performed by an URSP manager 930 as described with reference to FIG. 9.

At 1620, the method may include routing, via a higher layer of the UE based on the first set of URSP rules and on the capability of the UE, the data traffic associated with the UE via one or both of the first protocol stack or the second protocol stack. The operations of 1620 may be performed in accordance with examples as disclosed herein. In some examples, aspects of the operations of 1620 may be performed by a routing manager 935 as described with reference to FIG. 9.

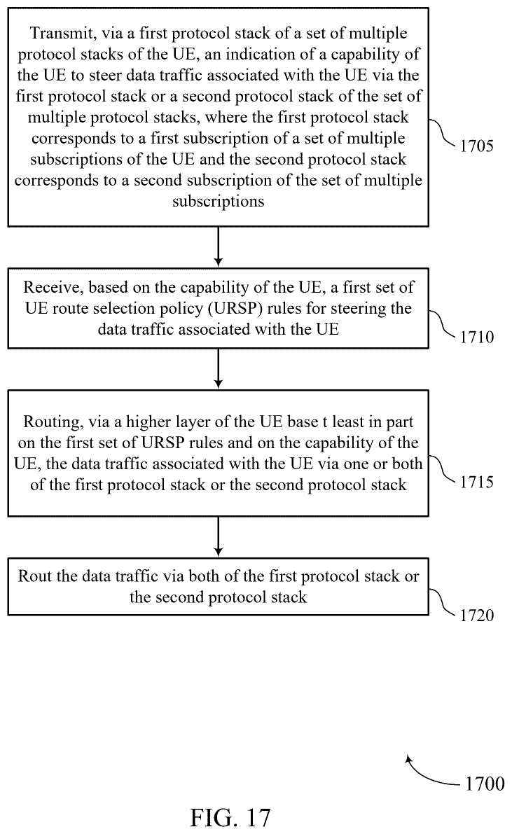

FIG. 17 shows a flowchart illustrating a method 1700 that supports dual-steering operations for wireless communications in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting, via a first protocol stack of a set of multiple protocol stacks of the UE, an indication of a capability of the UE to steer data traffic associated with the UE via the first protocol stack or a second protocol stack of the set of multiple protocol stacks, where the first protocol stack corresponds to a first subscription of a set of multiple subscriptions of the UE and the second protocol stack corresponds to a second subscription of the set of multiple subscriptions. The operations of 1705 may be performed in accordance with examples as disclosed herein. In some examples, aspects of the operations of 1705 may be performed by a capability transmitter 925 as described with reference to FIG. 9.

At 1710, the method may include receiving, based on the capability of the UE, a first set of URSP rules for steering the data traffic associated with the UE. The operations of 1710 may be performed in accordance with examples as disclosed herein. In some examples, aspects of the operations of 1710 may be performed by an URSP manager 930 as described with reference to FIG. 9.

At 1715, the method may include routing, via a higher layer of the UE based on the first set of URSP rules and on the capability of the UE, the data traffic associated with the UE via one or both of the first protocol stack or the second protocol stack. The operations of 1715 may be performed in accordance with examples as disclosed herein. In some examples, aspects of the operations of 1715 may be performed by a routing manager 935 as described with reference to FIG. 9.

At 1720, the method may include routing the data traffic via both of the first protocol stack or the second protocol stack. The operations of 1720 may be performed in accordance with examples as disclosed herein. In some examples, aspects of the operations of 1720 may be performed by a routing manager 935 as described with reference to FIG. 9.

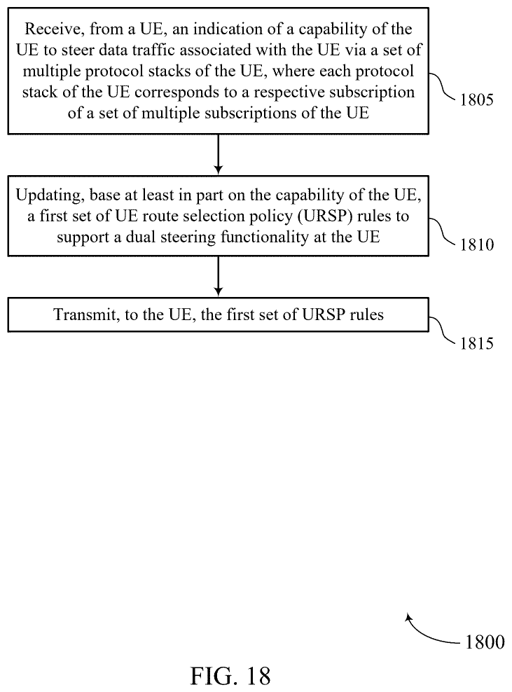

FIG. 18 shows a flowchart illustrating a method 1800 that supports dual-steering operations for wireless communications in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include receiving, from a UE, an indication of a capability of the UE to steer data traffic associated with the UE via a set of multiple protocol stacks of the UE, where each protocol stack of the UE corresponds to a respective subscription of a set of multiple subscriptions of the UE. The operations of 1805 may be performed in accordance with examples as disclosed herein. In some examples, aspects of the operations of 1805 may be performed by a capability receiver 1325 as described with reference to FIG. 13.

At 1810, the method may include updating, based on the capability of the UE, a first set of URSP rules to support a dual-steering functionality at the UE. The operations of 1810 may be performed in accordance with examples as disclosed herein. In some examples, aspects of the operations of 1810 may be performed by an URSP rules manager 1330 as described with reference to FIG. 13.

At 1815, the method may include transmitting, to the UE, the first set of URSP rules. The operations of 1815 may be performed in accordance with examples as disclosed herein. In some examples, aspects of the operations of 1815 may be performed by an URSP rules transmitter 1335 as described with reference to FIG. 13.

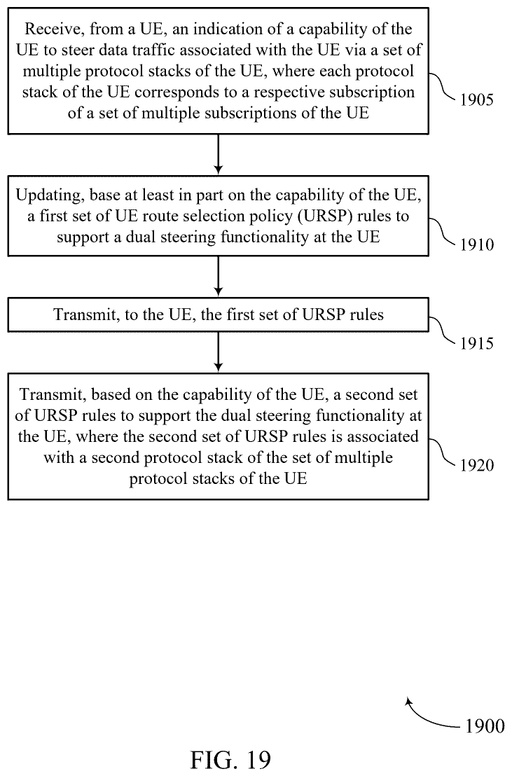

FIG. 19 shows a flowchart illustrating a method 1900 that supports dual-steering operations for wireless communications in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include receiving, from a UE, an indication of a capability of the UE to steer data traffic associated with the UE via a set of multiple protocol stacks of the UE, where each protocol stack of the UE corresponds to a respective subscription of a set of multiple subscriptions of the UE. The operations of 1905 may be performed in accordance with examples as disclosed herein. In some examples, aspects of the operations of 1905 may be performed by a capability receiver 1325 as described with reference to FIG. 13.

At 1910, the method may include updating, based on the capability of the UE, a first set of URSP rules to support a dual-steering functionality at the UE. The operations of 1910 may be performed in accordance with examples as disclosed herein. In some examples, aspects of the operations of 1910 may be performed by an URSP rules manager 1330 as described with reference to FIG. 13.

At 1915, the method may include transmitting, to the UE, the first set of URSP rules. The operations of 1915 may be performed in accordance with examples as disclosed herein. In some examples, aspects of the operations of 1915 may be performed by an URSP rules transmitter 1335 as described with reference to FIG. 13.

At 1920, the method may include transmitting, based on the capability of the UE, a second set of URSP rules to support the dual-steering functionality at the UE, where the second set of URSP rules is associated with a second protocol stack of the set of multiple protocol stacks of the UE. The operations of 1920 may be performed in accordance with examples as disclosed herein. In some examples, aspects of the operations of 1920 may be performed by an URSP rules transmitter 1335 as described with reference to FIG. 13.

The following provides an overview of aspects of the present disclosure:

Aspect 1: A method for wireless communications by a UE, comprising: transmitting, via a first protocol stack of a plurality of protocol stacks of the UE, an indication of a capability of the UE to steer data traffic associated with the UE via the first protocol stack or a second protocol stack of the plurality of protocol stacks, wherein the first protocol stack corresponds to a first subscription of a plurality of subscriptions of the UE and the second protocol stack corresponds to a second subscription of the plurality of subscriptions; receiving, based at least in part on the capability of the UE, a first set of UE route selection policy (URSP) rules for steering the data traffic associated with the UE; and routing, via a higher layer of the UE based at least in part on the first set of URSP rules and on the capability of the UE, the data traffic associated with the UE via one or both of the first protocol stack or the second protocol stack.

Aspect 2: The method of aspect 1, wherein the first set of URSP rules is received via the first protocol stack, the method further comprising: receiving, via the second protocol stack and based at least in part on the capability of the UE, a second set of URSP rules for steering the data traffic, wherein the first set of URSP rules is associated with the first protocol stack and the second set of URSP rules is associated with the second protocol stack.

Aspect 3: The method of any of aspects 1 through 2, wherein the first set of URSP rules is received via the higher layer of the UE and is associated with both the first protocol stack and the second protocol stack.

Aspect 4: The method of any of aspects 1 through 3, wherein each rule of the first set of URSP rules comprises a traffic descriptor and a set of route selection descriptors (RSDs), and wherein each RSD of the set of RSDs comprises: a preferred access type indicating whether to perform single steering or dual-steering; and a validity field indicating one or more RAT capabilities corresponding to one or more of the first protocol stack, the second protocol stack, the first subscription, or the second subscription, or any combination thereof.

Aspect 5: The method of aspect 4, wherein routing the data traffic via one or both of the first protocol stack or the second protocol stack comprises: routing the data traffic based at least in part on a first URSP rule, the first URSP rule based at least in part on traffic information associated with the data traffic and one or more traffic descriptors associated with one or more URSP rules of the first set of URSP rules.

Aspect 6: The method of aspect 5, wherein routing the data traffic based at least in part on the first URSP rule comprises: routing the data traffic via both the first protocol stack and the second protocol stack based at least in part on the preferred access type associated with a first RSD associated with the first URSP rule for use in routing the data traffic, the first RSD based at least in part on a capability of one or both of the first protocol stack and the second protocol stack and one or more validity indicators associated with one or more RSDs associated with the first URSP rule.

Aspect 7: The method of any of aspects 5 through 6, wherein routing the data traffic based at least in part on the first URSP rule comprises: routing the data traffic via one of the first protocol stack or the second protocol stack based at least in part on the preferred access type associated with a first RSD associated with the first URSP rule for use in routing the data traffic, the first RSD based at least in part on a capability associated with one or both of the first protocol stack and the second protocol stack and one or more validity indicators associated with one or more RSDs associated with the first URSP rule.

Aspect 8: The method of any of aspects 5 through 7, wherein routing the data traffic based at least in part on the first URSP rule comprises: routing the data traffic via one of the first protocol stack or the second protocol stack based at least in part on a first RSD associated with the first URSP rule for use in routing the data traffic, the first RSD based at least in part on one RSD being associated with the first URSP rule and the validity indicator associated with the first RSD being empty.

Aspect 9: The method of any of aspects 5 through 8, wherein each RSD of the set of RSDs comprises a subscription validity indicator identifying a protocol stack for routing the data traffic.

Aspect 10: The method of aspect 9, wherein routing the data traffic based at least in part on the first URSP rule comprises: routing the data traffic via the protocol stack identified by the subscription validity indicator associated with a first RSD based at least in part on the preferred access type associated with the first RSD indicating single steering, the first RSD associated with the first URSP rule for use in routing the data traffic and based at least in part on a capability of one or both of the first protocol stack and the second protocol stack and one or more validity indicators associated with one or more RSDs associated with the first URSP rule.

Aspect 11: The method of any of aspects 9 through 10, wherein routing the data traffic based at least in part on the first URSP rule comprises: routing the data traffic via one or both of the first protocol stack or the second protocol stack based on the subscription validity indicator associated with a first RSD associated with the first URSP rule for use in routing the data traffic being empty, the first RSD based at least in part on a capability of one or both of the first protocol stack and the second protocol stack and one or more validity indicators associated with one or more RSDs associated with the first URSP rule.

Aspect 12: The method of any of aspects 1 through 11, wherein routing the data traffic via one or both of the first protocol stack or the second protocol stack comprises: routing the data traffic via both of the first protocol stack or the second protocol stack.

Aspect 13: The method of aspect 12, further comprising: initiating, at the first protocol stack, a first packet data unit (PDU) session; initiating, at the second protocol stack, a second PDU session; transmitting, to a core network and via the first protocol stack, a first request to establish the first PDU session, wherein the first request indicates an identifier associated with the second protocol stack and an identifier associated with the second PDU session; and transmitting, to the core network and via the second protocol stack, a second request to establish the second PDU session, wherein the second request indicates an identifier associated with the first protocol stack and an identifier associated with the first PDU session.

Aspect 14: A method for wireless communications by a network entity, comprising: receiving, from a UE, an indication of a capability of the UE to steer data traffic associated with the UE via a plurality of protocol stacks of the UE, wherein each protocol stack of the UE corresponds to a respective subscription of a plurality of subscriptions of the UE; updating, based at least in part on the capability of the UE, a first set of UE route selection policy (URSP) rules to support a dual-steering functionality at the UE; and transmitting, to the UE, the first set of URSP rules.

Aspect 15: The method of aspect 14, wherein the first set of URSP rules is associated with a first protocol stack of the plurality of protocol stacks of the UE, the method further comprising: transmitting, based at least in part on the capability of the UE, a second set of URSP rules to support the dual-steering functionality at the UE, wherein the second set of URSP rules is associated with a second protocol stack of the plurality of protocol stacks of the UE.

Aspect 16: The method of any of aspects 14 through 15, wherein the first set of URSP rules is associated with the plurality of protocol stacks of the UE.

Aspect 17: The method of any of aspects 14 through 16, wherein each rule of the first set of URSP rules comprises a traffic descriptor and a set of route selection descriptors (RSDs), and wherein each RSD of the set of RSDs comprises: a preferred access type indicating whether to perform single steering or dual-steering; and a validity field indicating one or more RAT capabilities corresponding to one or more of a first protocol stack of the plurality of protocol stacks, a second protocol stack of the plurality of protocol stacks, a first subscription of the plurality of subscriptions, or a second subscription of the plurality of subscriptions, or any combination thereof.

Aspect 18: The method of aspect 17, wherein each RSD of the set of RSDs comprises a subscription validity indicator identifying which protocol stack of the plurality of protocol stacks of the UE to route traffic through.

Aspect 19: The method of any of aspects 14 through 18, further comprising: receiving, from the UE, a first request to establish a first PDU session associated with a first protocol stack of the plurality of protocol stacks of the UE, wherein the first request includes an indication of an identifier associated with a second protocol stack of the plurality of protocol stacks of the UE and an identifier associated with a second PDU session associated with the second protocol stack.

Aspect 20: The method of aspect 19, further comprising: receiving, from the UE, a second request to establish the second PDU session, wherein the second request includes an indication of an identifier associated with the first protocol stack and an identifier associated with the first PDU session.

Aspect 21: The method of aspect 20, further comprising: associating, based at least in part on receiving the first request and the second request, the first PDU session and the second PDU session with the UE.

Aspect 22: A UE for wireless communications, comprising one or more memories storing processor-executable code, and one or more processors coupled with the one or more memories and individually or collectively operable to execute the code to cause the UE to perform a method of any of aspects 1 through 13.

Aspect 23: A UE for wireless communications, comprising at least one means for performing a method of any of aspects 1 through 13.

Aspect 24: A non-transitory computer-readable medium storing code for wireless communications, the code comprising instructions executable by one or more processors to perform a method of any of aspects 1 through 13.

Aspect 25: A network entity for wireless communications, comprising one or more memories storing processor-executable code, and one or more processors coupled with the one or more memories and individually or collectively operable to execute the code to cause the network entity to perform a method of any of aspects 14 through 21.

Aspect 26: A network entity for wireless communications, comprising at least one means for performing a method of any of aspects 14 through 21.

Aspect 27: A non-transitory computer-readable medium storing code for wireless communications, the code comprising instructions executable by one or more processors to perform a method of any of aspects 14 through 21.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, via a first protocol stack of a plurality of protocol stacks of the UE, an indication of a capability of the UE to steer data traffic associated with the UE via the first protocol stack or a second protocol stack of the plurality of protocol stacks, wherein the first protocol stack corresponds to a first subscription of a plurality of subscriptions of the UE and the second protocol stack corresponds to a second subscription of the plurality of subscriptions;
receive, based at least in part on the capability of the UE, a first set of UE route selection policy (URSP) rules for steering the data traffic associated with the UE; and
routing, via a higher layer of the UE based at least in part on the first set of URSP rules and on the capability of the UE, the data traffic associated with the UE via one or both of the first protocol stack or the second protocol stack.

2. The UE of claim 1, wherein the first set of URSP rules is received via the first protocol stack, and the one or more processors are individually or collectively further operable to execute the code to cause the UE to:
receive, via the second protocol stack and based at least in part on the capability of the UE, a second set of URSP rules for steering the data traffic, wherein the first set of URSP rules is associated with the first protocol stack and the second set of URSP rules is associated with the second protocol stack.

3. The UE of claim 1, wherein the first set of URSP rules is received via the higher layer of the UE and is associated with both the first protocol stack and the second protocol stack.

4. The UE of claim 1, wherein each rule of the first set of URSP rules comprises a traffic descriptor and a set of route selection descriptors (RSDs), and wherein each RSD of the set of RSDs comprises:
a preferred access type indicate whether to perform single steering or dual-steering; and
a validity field indicate one or more radio access technology capabilities corresponding to one or more of the first protocol stack, the second protocol stack, the first subscription, or the second subscription, or any combination thereof.

5. The UE of claim 4, wherein, to route the data traffic via one or both of the first protocol stack or the second protocol stack, the one or more processors are individually or collectively operable to execute the code to cause the UE to:
route the data traffic based at least in part on a first URSP rule, the first URSP rule based at least in part on traffic information associated with the data traffic and one or more traffic descriptors associated with one or more URSP rules of the first set of URSP rules.

6. The UE of claim 5, wherein, to route the data traffic based at least in part on the first URSP rule, the one or more processors are individually or collectively operable to execute the code to cause the UE to:
route the data traffic via both the first protocol stack and the second protocol stack based at least in part on the preferred access type associated with a first RSD associated with the first URSP rule for use in routing the data traffic, the first RSD based at least in part on a capability of one or both of the first protocol stack and the second protocol stack and one or more validity indicators associated with one or more RSDs associated with the first URSP rule.

7. The UE of claim 5, wherein, to route the data traffic based at least in part on the first URSP rule, the one or more processors are individually or collectively operable to execute the code to cause the UE to:
route the data traffic via one of the first protocol stack or the second protocol stack based at least in part on the preferred access type associated with a first RSD associated with the first URSP rule for use in routing the data traffic, the first RSD based at least in part on a capability associated with one or both of the first protocol stack and the second protocol stack and one or more validity indicators associated with one or more RSDs associated with the first URSP rule.

8. The UE of claim 5, wherein, to route the data traffic based at least in part on the first URSP rule, the one or more processors are individually or collectively operable to execute the code to cause the UE to:
route the data traffic via one of the first protocol stack or the second protocol stack based at least in part on a first RSD associated with the first URSP rule for use in routing the data traffic, the first RSD based at least in part on one RSD being associated with the first URSP rule and the validity indicator associated with the first RSD being empty.

9. The UE of claim 5, wherein each RSD of the set of RSDs comprises a subscription validity indicator identifying a protocol stack for routing the data traffic.

10. The UE of claim 9, wherein, to route the data traffic based at least in part on the first URSP rule, the one or more processors are individually or collectively operable to execute the code to cause the UE to:
route the data traffic via the protocol stack identified by the subscription validity indicator associated with a first RSD based at least in part on the preferred access type associated with the first RSD indicating single steering, the first RSD associated with the first URSP rule for use in routing the data traffic and based at least in part on a capability of one or both of the first protocol stack and the second protocol stack and one or more validity indicators associated with one or more RSDs associated with the first URSP rule.

11. The UE of claim 9, wherein, to route the data traffic based at least in part on the first URSP rule, the one or more processors are individually or collectively operable to execute the code to cause the UE to:
route the data traffic via one or both of the first protocol stack or the second protocol stack based on the subscription validity indicator associated with a first RSD associated with the first URSP rule for use in routing the data traffic being empty, the first RSD based at least in part on a capability of one or both of the first protocol stack and the second protocol stack and one or more validity indicators associated with one or more RSDs associated with the first URSP rule.

12. The UE of claim 1, wherein, to route the data traffic via one or both of the first protocol stack or the second protocol stack, the one or more processors are individually or collectively operable to execute the code to cause the UE to:
route the data traffic via both of the first protocol stack or the second protocol stack.

13. The UE of claim 12, wherein the one or more processors are individually or collectively further operable to execute the code to cause the UE to:
initiate, at the first protocol stack, a first protocol data unit (PDU) session;
initiate, at the second protocol stack, a second PDU session;
transmit, to a core network and via the first protocol stack, a first request to establish the first PDU session, wherein the first request indicates an identifier associated with the second protocol stack and an identifier associated with the second PDU session; and
transmit, to the core network and via the second protocol stack, a second request to establish the second PDU session, wherein the second request indicates an identifier associated with the first protocol stack and an identifier associated with the first PDU session.

14. A network entity, comprising:
one or more memories storing processor-executable code; and
one or more processors coupled with the one or more memories and individually or collectively operable to execute the code to cause the network entity to:
receive, from a user equipment (UE), an indication of a capability of the UE to steer data traffic associated with the UE via a plurality of protocol stacks of the UE, wherein each protocol stack of the UE corresponds to a respective subscription of a plurality of subscriptions of the UE;
updating, based at least in part on the capability of the UE, a first set of UE route selection policy (URSP) rules to support a dual-steering functionality at the UE; and
transmit, to the UE, the first set of URSP rules.

15. The network entity of claim 14, wherein the first set of URSP rules is associated with a first protocol stack of the plurality of protocol stacks of the UE, and the one or more processors are individually or collectively further operable to execute the code to cause the network entity to:
transmit, based at least in part on the capability of the UE, a second set of URSP rules to support the dual-steering functionality at the UE, wherein the second set of URSP rules is associated with a second protocol stack of the plurality of protocol stacks of the UE.

16. The network entity of claim 14, wherein the first set of URSP rules is associated with the plurality of protocol stacks of the UE.

17. The network entity of claim 14, wherein each rule of the first set of URSP rules comprises a traffic descriptor and a set of route selection descriptors (RSDs), and wherein each RSD of the set of RSDs comprises:
a preferred access type indicating whether to perform single steering or dual-steering; and
a validity field indicating one or more radio access technology capabilities corresponding to one or more of a first protocol stack of the plurality of protocol stacks, a second protocol stack of the plurality of protocol stacks, a first subscription of the plurality of subscriptions, or a second subscription of the plurality of subscriptions, or any combination thereof.

18. The network entity of claim 14, wherein the one or more processors are individually or collectively further operable to execute the code to cause the network entity to:
receive, from the UE, a first request to establish a first PDU session associated with a first protocol stack of the plurality of protocol stacks of the UE, wherein the first request includes an indication of an identifier associated with a second protocol stack of the plurality of protocol stacks of the UE and an identifier associated with a second PDU session associated with the second protocol stack.

19. The network entity of claim 18, wherein the one or more processors are individually or collectively further operable to execute the code to cause the network entity to:
receive, from the UE, a second request to establish the second PDU session, wherein the second request includes an indication of an identifier associated with the first protocol stack and an identifier associated with the first PDU session; and
associate, based at least in part on receiving the first request and the second request, the first PDU session and the second PDU session with the UE.

20. A method for wireless communications by a user equipment (UE), comprising:
transmitting, via a first protocol stack of a plurality of protocol stacks of the UE, an indication of a capability of the UE to steer data traffic associated with the UE via the first protocol stack or a second protocol stack of the plurality of protocol stacks, wherein the first protocol stack corresponds to a first subscription of a plurality of subscriptions of the UE and the second protocol stack corresponds to a second subscription of the plurality of subscriptions;
receiving, based at least in part on the capability of the UE, a first set of UE route selection policy (URSP) rules for steering the data traffic associated with the UE; and
routing, via a higher layer of the UE based at least in part on the first set of URSP rules and on the capability of the UE, the data traffic associated with the UE via one or both of the first protocol stack or the second protocol stack.
